(19) United States
(12) Patent Application Publication
(10) Pub. No.: US 2013/0325653 A1
(43) Pub. Date: Dec. 5, 2013

(54) Commerce System and Method of Providing Personalized Marketing Presentation with Products of Interest for Consumer

(71) Applicant: Kenneth J. Ouimet, Scottsdale, AZ (US)

(72) Inventor: Kenneth J. Ouimet, Scottsdale, AZ (US)

(73) Assignee: MYWORLD, INC., Scottsdale, AZ (US)

(21) Appl. No.: 13/489,195

(22) Filed: Jun. 5, 2012

(51) Int. Cl. G06Q 30/06

(52) U.S. Cl. 705/26.7

(57) ABSTRACT

A commerce system has retailers offering products for sale to consumers. Product information is collected associated with a plurality of products. Products of interest are presented to a first consumer based on the product information. The products of interest are selected based on a prior product selection by the first consumer, product selections by a second consumer, or retailer promoted products. The products of interest include comparative product information from a plurality of retailers. A shopping list is generated including one or more selected products of interest as determined by the first consumer. The shopping list including the selected products of interest is made available to the first consumer to assist with a purchasing decision. The purchasing decision within the commerce system is controlled by enabling the first consumer to select products for purchase based on the shopping list including the selected products of interest.

### FIELD OF THE INVENTION

The present invention relates in general to consumer purchasing and, more particularly, to a commerce system and method of providing a personalized marketing presentation with products of interest for a consumer.

### BACKGROUND OF THE INVENTION

Business planning is commonly used in commercial ventures. In the retail environment, grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. The retailer can change the business plan as needed.

On the other side of the transaction, consumers are interested in quality, low prices, comparative product features, convenience, and receiving the most value for the money. For the consumer, some comparative product information can be gathered from various electronic and paper sources, such as online websites, paper catalogs, and media advertisements. However, such product information is sponsored by the retailer and slanted at best, typically limited to the specific retailer offering the product and presented in a manner favorable to the retailer. That is, the product information released by the retailer is subjective and incomplete, i.e., the consumer only sees what the retailer wants the consumer to see. For example, the product description may not include all product features or attributes of interest to the consumer, or the product description may not include comparative pricing between competing retailers.

Alternatively, the consumer can visit all retailers offering a particular type of product and record the various prices, product descriptions, and retailer amenities to make a purchase decision. The brute force approach of one person physically traveling to or otherwise researching each retailer for all product information is impractical for most people. Many people do compare multiple retailers, e.g., when shopping online, particularly for big ticket items. Yet, the time people are willing to spend reviewing product information decreases rapidly with price. Little time is spent reviewing commodity items. In any case, the consumer has limited time to do comparative shopping and mere searching does not constitute an optimization of the purchasing decision. Optimization requires access to data, i.e., comprehensive, reliable, efficient, and objective product information, so the consumer remains hampered in achieving a level playing field with the retailer.

In a highly competitive market, the profit margin is paper-thin and consumer loyalty is at a premium. Retailers should consider opportunities that assist the consumer with the purchasing decision, particularly if that opportunity may lead to a sale for the retailer and potentially a loyal customer. The retailers remain motivated to optimize the business plan and marketing strategy to maximize profit and revenue.

### SUMMARY OF THE INVENTION

A need exists for retailers to build market share and increase sales, revenue, and profit. Accordingly, in one embodiment, the present invention is a method of controlling a commerce system comprising the steps of collecting product information associated with a plurality of products, and presenting a plurality of products of interest to a first consumer based on the product information. The products of interest include comparative product information from a plurality of retailers. The method further includes the steps of generating a shopping list including one or more selected products of interest as determined by the first consumer, providing the shopping list including the selected products of interest to the first consumer to assist with a purchasing decision, and controlling the purchasing decision within the commerce system by enabling the first consumer to select products for purchase based on the shopping list including the selected products of interest.

In another embodiment, the present invention is a method of controlling a commerce system comprising the steps of collecting product information associated with a plurality of products, presenting a plurality of products of interest to a first consumer including comparative product information from a plurality of retailers, and generating a shopping list including one or more selected products of interest as determined by the first consumer.

In another embodiment, the present invention is a method of controlling a commerce system comprising the steps of collecting product information associated with a plurality of products, and presenting a plurality of products of interest to a first consumer including comparative product information from a plurality of retailers.

In another embodiment, the present invention is a computer program product usable with a programmable computer processor having a computer readable program code embodied in a tangible computer usable medium for controlling a commerce system comprising the steps of collecting product information associated with a plurality of products, and presenting a plurality of products of interest to a first consumer including comparative product information from a plurality of retailers.

### BRIEF DESCRIPTION OF THE DRAWINGS

FIG. 1 illustrates a retailer engaged in commercial activity with a consumer;

FIG. 2 illustrates a commercial system with a manufacturer, distributor, retailer, and consumer;

FIG. 3 illustrates commercial transactions between consumers and retailers with the aid of a consumer service provider;

FIG. 4 illustrates an electronic communication network between members of the commerce system;

FIG. 5 illustrates a computer system operating with the electronic communication network;

FIG. 6 illustrates a consumer profile registration webpage with the consumer service provider;

FIG. 7 illustrates a consumer login webpage for the consumer service provider;

FIG. 8 illustrates commercial interaction between the consumers, retailers, and consumer service provider to generate an optimized shopping list with discount offers;

FIG. 9 illustrates collecting product information from retailer websites directly by the consumer service provider or indirectly using consumer computers;

FIG. 10 illustrates a plurality of products organized into a product family;

FIG. 11 illustrates a product family for yogurt products having similar attributes;

FIG. 12 illustrates a product family for rice products having similar attributes;

FIG. 13 illustrates a product family for paper towel products having similar attributes;

FIG. 14 illustrates a product family for liquid laundry detergent products having similar attributes;

FIG. 15 illustrates a home webpage for the consumer when communicating with the consumer service provider;

FIG. 16 illustrates a search webpage for the consumer to locate preferred retailers on a map;

FIG. 17 illustrates a plurality of links to consumer shopping lists;

FIG. 18 illustrates a webpage for the consumer to select product categories when creating or modifying the shopping list;

FIG. 19 illustrates a dairy products webpage for the consumer to select product attributes and assign weighting factors;

FIG. 20 illustrates a breakfast cereal webpage for the consumer to select product attributes and assign weighting factors;

FIG. 21 illustrates a cell phone for the consumer to select product attributes and assign weighting factors;

FIG. 22 illustrates creating an optimized shopping list from the consumer-defined product attributes and weighting factors and product information stored in a database;

FIG. 23 illustrates selection of a retailer with the highest net value product;

FIG. 24 illustrates an optimized shopping list to aid the consumer with purchasing decisions;

FIG. 25 illustrates products proposed for the optimized shopping list based on a marketing strategy;

FIG. 26 illustrates products for the optimized shopping list based on product categories in a virtual retailer;

FIGS. 27a-27b illustrate demand curves of price versus unit sales;

FIG. 28 illustrates clustering preferred products and making a product recommendation to a consumer;

FIG. 29 illustrates an optimized shopping list with product recommendations;

FIG. 30 illustrates a cell phone with product recommendations;

FIG. 31 illustrates a personalized deal page for presenting products of interest for the consumer;

FIG. 32 illustrates selecting products of interest based on prior product selections, recommended products, and retailer promoted products;

FIG. 33 illustrates an optimized shopping list including products of interest selected by the consumer; and

FIG. 34 illustrates the process of controlling activities within the commerce system by enabling a consumer to select a product recommendation for purchase.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors, a business must look for every advantage it can muster in maximizing market share and profits. The ability to consider factors which materially affect overall revenue and profitability and adjust the business plan accordingly is vital to the success of the bottom line, and the fundamental need to not only survive but to prosper and grow.

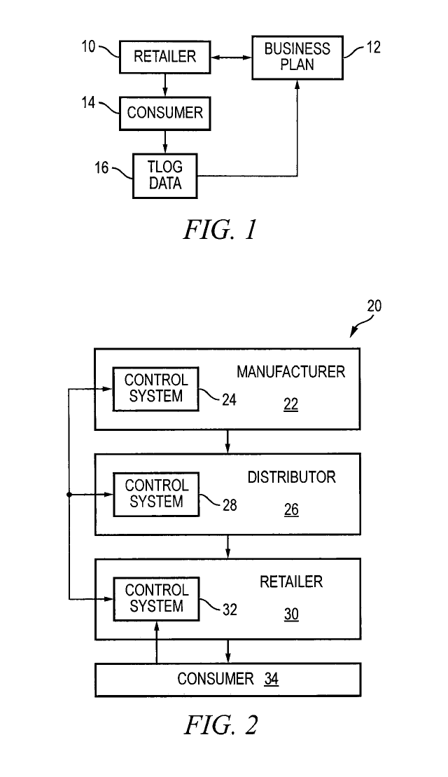

Referring to FIG. 1, retailer 10 has certain product lines or services available to consumers as part of its business plan 12. The terms products and services are interchangeable in the commercial system. Retailer 10 can be a food store, general consumer product retailer, drug store, discount warehouse, department store, apparel store, specialty store, or service provider. Retailer 10 operates under business plan 12 to set pricing, order inventory, formulate and run promotions, add and remove product lines, organize product shelving and displays, select signage, hire employees, expand stores, collect and maintain historical sales data, evaluate performance and trends, and make strategic decisions. Retailer 10 can change business plan 12 as needed. While the present discussion will involve a retailer, it is understood that the system described herein is applicable to data analysis for other members in the chain of commerce, or other industries and businesses having similar goals, constraints, and needs.

Retailer 10 routinely enters into sales transactions with customer or consumer 14. In fact, retailer 10 maintains and updates its business plan 12 to increase the number of transactions (and thus revenue and/or profit) between retailer 10 and consumer 14. Consumer 14 can be a specific individual, account, or business entity.

For each sale transaction entered into between retailer 10 and consumer 14, information is stored in transaction log (T-LOG) data 16. When a consumer goes through the checkout at a grocery store or any other retail store, each of the items to be purchased is scanned and data is collected and stored by a point-of-sale (POS) system, or other suitable data collection system, in T-LOG data 16. The data includes the then current price, promotion, and merchandizing information associated with the product along with the units purchased, and the dollar sales. The time, date, store, and consumer information corresponding to that purchase are also recorded.

T-LOG data 16 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 16 is accurate, observable, and granular product information based on actual retail transactions within the store. T-LOG data 16 represents the known and observable results from the consumer buying decision or process. T-LOG data 16 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T5 on day/time D3 has promotion PROMO5 as a $0.50 rebate. Product P8 in transaction T6 has no promotional offering. A promotion may also be classified as a combination of promotions, e.g., flyer with sale price, end-cap with rebate, or individualized discounted offer as described below.

Retailer 10 may also provide additional information to T-LOG data 16 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 16.

In FIG. 2, a commerce system 20 is shown involving the movement of goods between members of the system. Manufacturer 22 produces goods in commerce system 20. Manufacturer 22 uses control system 24 to receive orders, control manufacturing and inventory, and schedule deliveries. Distributor 26 receives goods from manufacturer 22 for distribution within commerce system 20. Distributor 26 uses control system 28 to receive orders, control inventory, and schedule deliveries. Retailer 30 receives goods from distributor 26 for sale within commerce system 20. Retailer 30 uses control system 32 to place orders, control inventory, and schedule deliveries with distributor 26. Retailer 30 sells goods to consumer 34. Consumer 34 patronizes retailer's establishment either in person or by using online ordering. The consumer purchases are entered into control system 32 of retailer 30 as T-LOG data 16.

The purchasing decisions made by consumer 34 drive the manufacturing, distribution, and retail portions of commerce system 20. More purchasing decisions made by consumer 34 for retailer 30 lead to more merchandise movement for all members of commerce system 20. Manufacturer 22, distributor 26, and retailer 30 utilize respective control systems 24, 28, and 32, to control and optimize the ordering, manufacturing, distribution, sale of the goods, and otherwise execute respective business plan 12 within commerce system 20 in accordance with the purchasing decisions made by consumer 34.

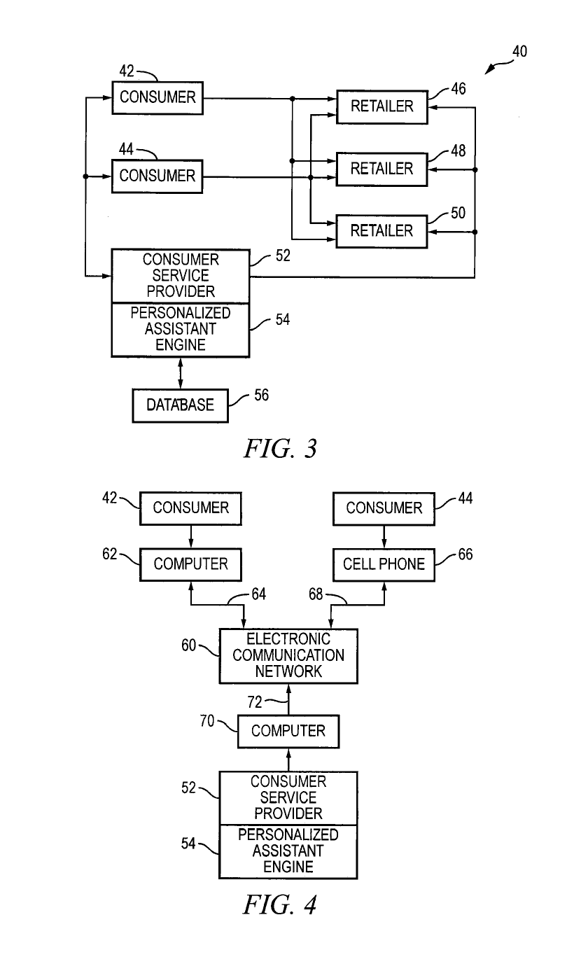

FIG. 3 illustrates a commerce system 40 with consumers 42 and 44 engaged in purchasing transactions with retailers 46, 48, and 50. Retailers 46-50 are supplied by manufacturers and distributors, as described in FIG. 2. Retailers 46-50 are typically local to consumers 42-44, i.e., retailers that the consumers will likely patronize. Retailers 46-50 can also be remote from consumers 42-44 with transactions handled by electronic communication medium, e.g., phone or online website via personal computer, and delivered electronically or by common carrier, depending on the nature of the goods. Consumers 42-44 patronize retailers 46-50 by selecting one or more items for purchase from one or more retailers. For example, consumer 42 can visit the store of retailer 46 in person and select product P1 for purchase. Consumer 42 can contact retailer 48 by phone or email and select product P2 for purchase. Consumer 44 can browse the website of retailer 50 using a personal computer and select product P3 for purchase. Accordingly, consumers 42-44 and retailers 46-50 regularly engage in commercial transactions within commerce system 40.

As described herein, manufacturer 22, distributor 26, retailers 46-50, consumers 42-44, and consumer service provider 52 are considered members of commerce system 40. The retailer generally refers to the seller of the product and consumer generally refers to the buyer of the product. Depending on the transaction within commerce system 40, manufacturer 22 can be the seller and distributor 26 can be the buyer, or distributor 26 can be the seller and retailers 46-50 can be the buyer, or manufacturer 22 can be the seller and consumers 42-44 can be the buyer.

A consumer service provider 52 is a part of commerce system 40. Consumer service provider 52 is a third party that assists consumers 42-44 with the product evaluation and purchasing decision process by providing access to a comparative shopping service. More specifically, consumer service provider 52 operates and maintains personal assistant engine 54 that prioritizes product attributes and optimizes product selection according to consumer-weighted preferences. The product attributes and consumer-weighted preferences are stored in database 56. In addition, personal assistant engine 54 generates a discounted offer for a product to entice a positive purchasing decision by a specific consumer. Personalized assistant engine 54 saves the consumer considerable time and money by providing access to a comprehensive, reliable, and objective optimization model or comparative shopping service.

Each consumer goes through a product evaluation and purchasing decision process each time a particular product is selected for purchase. Some product evaluations and purchasing decision processes are simple and routine. For example, when consumer 42 is conducting weekly shopping in the grocery store, the consumer considers a needed item or item of interest, e.g., canned soup. Consumer 42 may have a preferred brand, size, and flavor of canned soup. Consumer 42 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 42 may pause during the product evaluation and purchasing decision process and consider other canned soup options. Consumer 42 may want to try a different flavor or another brand offering a lower price. As the price of the product increases, the product evaluation and purchasing decision process usually becomes more involved. If consumer 42 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective comparative shopping service. The comparative shopping service assists the consumer in finding the optimal price and product attributes, e.g., brand, quality, quantity, size, features, ingredients, service, warranty, and convenience, that are important to the consumer and tip the purchasing decision toward selecting a particular product and retailer.

Personal assistant engine 54 can be made available to consumers 42-44 via computer-based online website or other electronic communication medium, e.g., wireless cell phone or other personal communication device. FIG. 4 shows an electronic communication network 60 for transmitting information between consumers 42-44, consumer service provider 52, and retailers 46-50. Consumer 42 operating with computer 62 is connected to electronic communication network 60 by way of communication channel or link 64. Likewise, consumer 44 operating with a cellular telephone, smart phone, or other wireless communication device 66 is connected to electronic communication network 60 by way of communication channel or link 68. Consumer service provider 52 uses computer 70 to communicate with electronic communication network 60 over communication channel or link 72. The electronic communication network 60 is a distributed network of interconnected routers, gateways, switches, and servers, each with a unique internet protocol (IP) address to enable communication between individual computers, cellular telephones, electronic devices, or nodes within the network. In one embodiment, electronic communication network 60 is a cell phone service network. Alternatively, communication network 60 is a global, open-architecture network, commonly known as the Internet. Communication channels 64, 68, and 72 are bi-directional and transmit data between computers 62 and 70 and cell phone 66 and electronic communication network 60 in a hard-wired or wireless configuration. For example, computers 62 and 70 have email, texting, and Internet capability, and consumer cell phone 66 has email, mobile applications (apps), texting, and Internet capability.

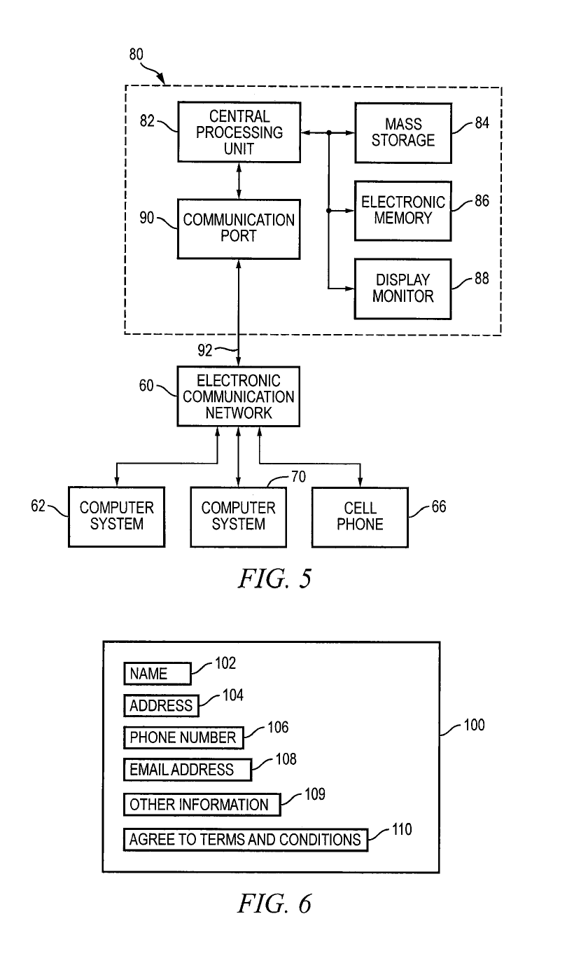

Further detail of the computer systems used in electronic communication network 60 is shown in FIG. 5 as a simplified computer system 80 for executing the software program used in the electronic communication process. Computer system 80 is a general purpose computer including a processing unit or microprocessor 82, mass storage device or hard disk 84, electronic memory 86, display monitor 88, and communication port 90. Communication port 90 represents a modem, high-speed Ethernet link, wireless, or other electronic connection to transmit and receive input/output (I/O) data over communication link 92 to electronic communication network 60. Computer system or server 62 and 70 can be configured as shown for computer 80. Computer system 62 and 70 and cell phone 66 transmit and receive information and data over communication network 60.

Computer systems 62, 70, and 80 can be physically located in any location with access to a modem or communication link to network 60. For example, computer systems 62, 70, and 80 can be located in a home or business office. Consumer service provider 52 may use computer systems 62, 70, or 80 in its business office. Alternatively, computer systems 62, 70, or 80 can be mobile and follow the user to any convenient location, e.g., remote offices, consumer locations, hotel rooms, residences, vehicles, public places, or other locales with electronic access to electronic communication network 60. The consumer can access consumer service provider 52 by mobile app operating in cell phone 66.

Each of the computers runs application software and computer programs, which can be used to display user interface screens, execute the functionality, and provide the electronic communication features as described below. The application software includes an Internet browser, local email application, mobile apps, word processor, spreadsheet, and the like. In one embodiment, the screens and functionality come from the application software, i.e., the electronic communication runs directly on computer systems 62, 70, and 80. Alternatively, the screens and functions are provided remotely from one or more websites on servers within electronic communication network 60.

The software is originally provided on computer readable media, such as compact disks (CDs), external drive, or other mass storage medium. Alternatively, the software is downloaded from electronic links, such as the host or vendor website. The software is installed onto the computer system hard drive 84 and/or electronic memory 86, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 62, 70, and 80 run application software to execute instructions for communication between consumers 42 and 44 and consumer service provider 52 to generate shopping lists and make recommendations for consumers. Cell phone 66 runs one or more mobile apps to execute instructions for communication between consumers 42 and 44 and consumer service provider 52 to generate shopping lists and make recommendations for consumers. The application software is an integral part of the control of commercial activity within commerce system 40.

To interact with consumer service provider 52, consumers 42 and 44 first create an account and profile with the consumer service provider. Consumers 42 and 44 can use some features offered by consumer service provider 52 without creating an account, but full access requires completion of a registration process. The consumer accesses website 100 operated by consumer service provider 52 on computer systems 62, 70, or 80 and provides data to complete the registration and activation process, as shown in FIG. 6. The consumer can access website 100 using cell phone 66 or computer systems 62, 70, or 80 by typing the uniform resource locator (URL) for website 100, or by clicking on a banner located on another website which re-directs the consumer to a predetermined landing page for website 100. The data provided by the consumer to consumer service provider 52 may include name in block 102, home address and work address with zip code in block 104, phone number in block 106, email address in block 108, and other information and credentials in block 109 necessary to establish a profile, identity, and general preferences for the consumer. The consumer's home and work address and zip code are important as shopping is often a local activity. The consumer agrees to the terms and conditions of conducting electronic communication through consumer service provider 52 in block 110.

The profile can also contain information related to the shopping habits and preferences of consumers 42-44. For example, the other information in block 109 includes product preferences, consumer characteristics, and consumer demographics, e.g., gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumers 42-44 can specify preferred retailers and spending patterns. Alternatively, retailers 46-50 can provide T-LOG data 16 to consumer service provider 52 to accurately track the shopping patterns of consumers 42-44. Consumer surface provider 52 will have records of consumer loyalty and value to each retailer. Consumer value is based on spending patterns of the consumer.

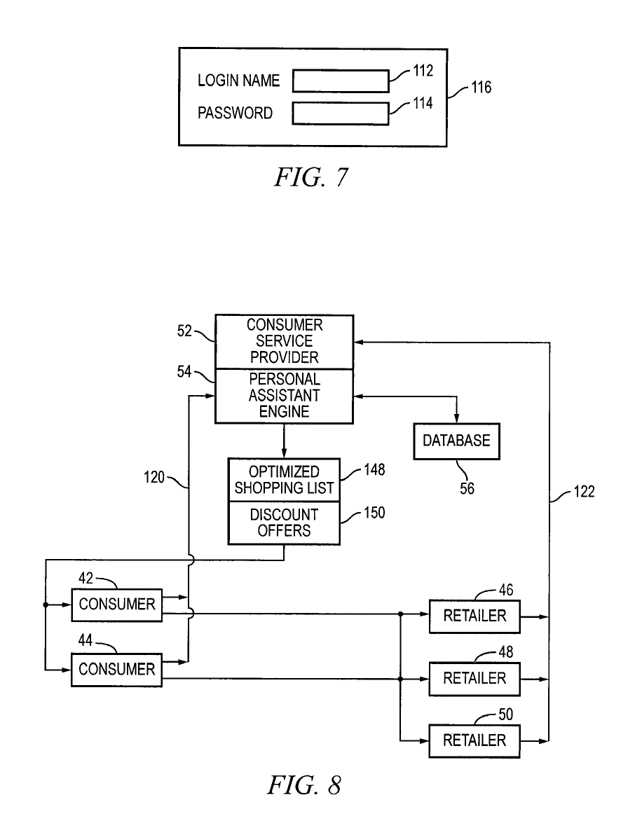

The consumer's profile is stored and maintained within database 56. The consumer can access and update his or her profile or interact by entering login name 112 and password 114 in webpage 66, as shown in FIG. 7. The consumer name can be any personal name, user name, number, or email address that uniquely identifies the consumer and the password can be assigned to or selected by the consumer. Accordingly, the consumer's profile and personal data remain secure and confidential within database 56 by consumer service provider 52.

One feature of personal assistant engine 54 allows the consumer to enter a list of products of interest or need, i.e., to create a shopping list. FIG. 8 illustrates consumers 42 and 44 in communication with personal assistant engine 54 by electronic link 120. Once logged-in to consumer service provider 52, consumers 42 and 44 can provide commonly purchased products or anticipated purchase products in the form of a shopping list to personal assistant engine 54 for storage in database 56. Each product will have product attributes weighted by consumer preference. The consumer weighted attribute values reflect the level of importance or preference that the consumer bestows on each product attribute. The available product attributes can be product-specific attributes, diet/health/nutrient related product attributes, lifestyle related product attributes, environment related product attributes, allergen related product attributes, and social/society related product attributes. The product-specific attributes can include brand, ingredients, size, price, freshness, retailer preference, warranty, and the like. The consumer can also identify a specific preferred retailer as an attribute with an assigned preference level based on convenience and personal experience.

Personal assistant engine 54 stores the shopping list and weighted product attributes of each consumer in database 56 for future reference and updating. Personal assistant engine 54 can also store prices, product descriptions, names and locations of the retail stores selling the products, offer histories, purchase histories, as well as various rules, policies and algorithms. The individual products in the shopping list can be added or deleted and the weighted product attributes can be changed by the consumer. The shopping list entered into personal assistant engine 54 is defined by each consumer and allows consumer service provider 52 to track products and preferred retailers as selected by the consumer.

Consumers 42 and 44 utilize consumer service provider 52 and personal assistant engine 54 to assist with the shopping process. In general, consumers 42 and 44 provide a list of products with weighted attributes. Personal assistant engine 54 generates an optimized shopping list 148, with discounted offers 150, from the list of consumer-weighted product attributes. The discounted offers 150 can include default discount offers and individualized discount offers. Consumers 42 and 44 use optimized shopping list 148 and discounted offers 150 to patronize retailers 46-50. The transactions between consumers 42 and 44 and retailers 46-50, i.e., the actual purchasing decisions, are transmitted back to consumer service provider 52 by communication link 120 to evaluate the consumer's utilization of optimized shopping list 148 and discounted offers 150.

In order to store and maintain a shopping list for each consumer, personal assistant engine 54 must have access to up-to-date, comprehensive, reliable, and objective retailer product information. Consumer service provider 52 maintains database 56 with up-to-date, comprehensive, reliable, and objective retailer product information. The product information includes the product description, product attributes, regular retail pricing, and discounted offers. Consumer service provider 52 must actively and continuously gather up-to-date product information in order to maintain database 56. In one approach to gathering product information, retailers 46-50 may grant access to T-LOG data 16 for use by consumer service provider 52. T-LOG data 16 collected during consumer check-out can be sent electronically from retailers 46-50 to consumer service provider 52, as shown by communication link 122 in FIG. 8. Retailers 46-50 may be reluctant to grant access to T-LOG data 16, particularly without quid pro quo. However, as consumer service provider 52 gains acceptance and consumers 42-44 come to rely on the service to make purchasing decisions, retailers 46-50 will be motivated to participate.

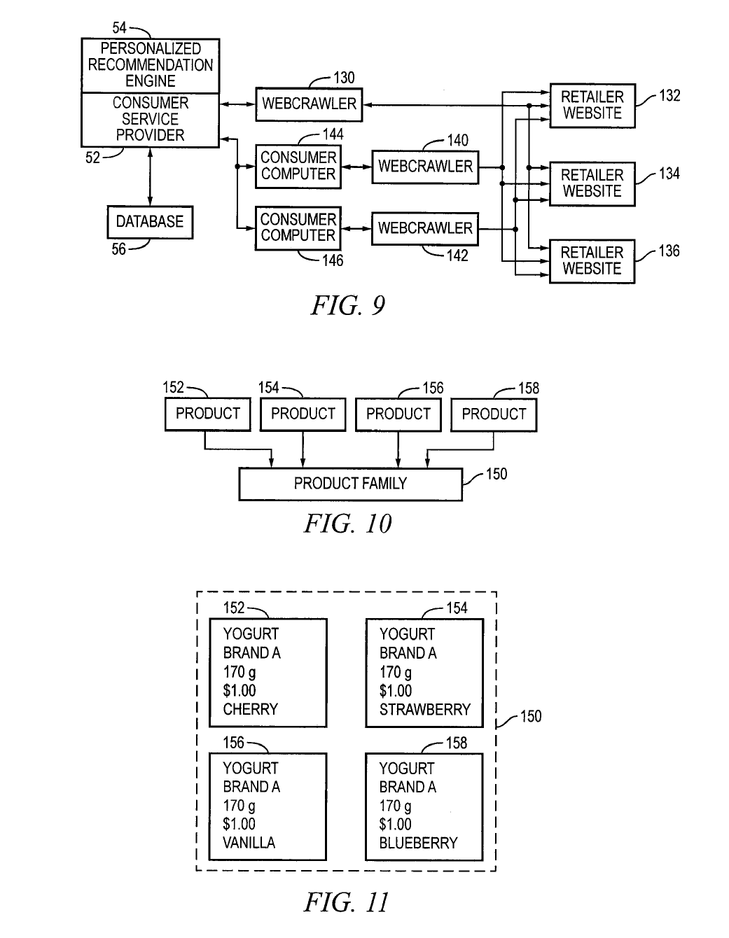

One or more retailers 46-50 may decline to provide access to its T-LOG data for use with personal assistant engine 54. In such cases, consumer service provider 52 can exercise a number of alternative data gathering approaches and sources. In one embodiment, consumer service provider 52 utilizes computer-based webcrawlers or other searching software to access retailer websites for pricing and other product information. In FIG. 9, webcrawler 130 operates within the software of computer systems 62, 70, or 80 used by consumer service provider 52. Consumer service provider 52 dispatches webcrawler 130 to make requests for product information from websites or portals 132, 134, and 136 of retailers 46, 48, and 50, respectively. Webcrawler 130 collects and returns the product information to personal assistant engine 54 for storage within database 56. For example, webcrawler 130 identifies products available from each of retailer websites 132-136 and requests pricing and other product information for each of the identified products. Webcrawler 130 navigates and parses each page of retailer websites 132-136 to locate pricing and other product information. The parsing operation involves identifying and recording product description, universal product code (UPC), price, ingredients, size, and other product information as recovered by webcrawler 130 from retailer websites 132-136. In particular, the parsing operation can identify discounted offers and special pricing from retailers 46-50. The discounted pricing can be used in part to formulate individualized “one-to-one” offers. The product information from retailer websites 132-136 is sorted and stored in database 56.

Consumer service provider 52 can also dispatch webcrawlers 140 and 142 from computers 144 and 146 used by consumers 42-44, or from consumer cell phone 66, or other electronic communication device, to access and request product information from retailer websites or portals 132-136 or other electronic communication medium or access point. During the registration process of FIG. 6, consumer service provider 52 acquires the IP address of consumer computers 144 and 146, as well as the permission of the consumers to utilize the consumer computer and login to access retailer websites 132-136. Consumer service provider 52 causes webcrawlers 140-142 to be dispatched from consumer computers 144-146 and uses the consumer login to retailer websites 132-136 to access and request product information from retailers 46-50. Webcrawlers 140-142 collect the product information from retailer websites 132-136 through the consumer computer and login and return the product information to personal assistant engine 54 for storage within database 56. The execution of webcrawlers 140-142 from consumer computers 144-146 distributes the computational work.

For example, the consumer logs into the website of consumer service provider 52 via webpage 116. Consumer service provider 52 initiates webcrawler 140 in the background of consumer computer 144 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 140 executes from consumer computer 144 and uses the consumer's login to gain access to retailer websites 132-136. Alternatively, webcrawler 140 resides permanently on consumer computer 144 and runs periodically. Webcrawler 140 identifies products available from each of retailer websites 132-136 and requests pricing and other product information for each of the identified products. Webcrawler 140 navigates and parses each page of retailer websites 132-136 to locate pricing and other product information. The parsing operation involves identifying and recording product description, UPC, price, ingredients, size, and other product information as recovered by webcrawler 140 from retailer websites 132-136. In particular, the parsing operation can identify discounted offers and special pricing from retailers 46-50. The discounted pricing can be used in part to formulate individualized “one-to-one” discounted offers. The product information from retailer websites 132-136 is sorted and stored in database 56.

Likewise, webcrawler 142 uses consumer computer 146 and login to gain access to retailer websites 132-136. Webcrawler 142 identifies products available from each of retailer websites 132-136 and requests pricing and other product information for each of the identified products. Webcrawler 142 navigates and parses each page of retailer websites 132-136 to locate pricing and other product information. The parsing operation involves identifying and recording product description, UPC, price, ingredients, size, and other product information as recovered by webcrawler 142 from retailer websites 132-136. In particular, the parsing operation can identify discounted offers and special pricing from retailers 46-50. The discounted pricing can be used in part to formulate individualized “one-to-one” discounted offers. The product information from retailer websites 132-136 is sorted and stored in database 56. The product information can be specific to the consumer's login. Retailers 46-50 are likely to accept product information requests from webcrawlers 140-142 because the requests originate from consumer computers 144-146 by way of the consumer login to the retailer website.

Consumer service provider 52 can also collect product information from discounted offers transmitted from retailers 46-50 directly to consumers 42-44, e.g., by email or cell phone 66. Consumer 42-44 can make the personalized discounted offers and other product information available to consumer service provider 52.

The product information in database 56 can be organized into product families based on similarity or commonality of brand, price, size, and related product attributes. Given the product information collected by webcrawlers 130, 140, and 142, or the product information provided by retailers 46-50, i.e., T-LOG data 16, or the product information provided by consumers 42-44, consumer service provider 52 organizes the individual products into product families. FIG. 10 shows individual products 152, 154, 156, and 158 organized into product family 150. In one example, product 152 is a yogurt product under brand A with package size of 170 grams (g), price of $1.00, and list of attributes or ingredients that include cherry flavoring, as shown in FIG. 11. Product 154 is a yogurt product under brand A with package size of 170 g, price of $1.00, and list of attributes or ingredients that include strawberry flavoring. Product 156 is a yogurt product under brand A with package size of 170 g, price of $1.00, and list of attributes or ingredients that include vanilla flavoring. Product 158 is a yogurt product under brand A with package size of 170 g, price of $1.00, and list of attributes or ingredients that include blueberry flavoring. Consumer service provider 52 analyzes the product information of products 152-158 and determines that the products differ in the flavoring of the yogurt and otherwise have common product attributes. Consumer service provider 52 groups products 152-158 into product family 150 with common brand, size, price, or related product attribute. Product family 150 is stored in database 56 for each product 152-158.

When accessing products 152-158 for optimized shopping list 148, database 56 returns product family 150 to simplify the presentation of the products in the optimized shopping list. Although products 152-158 have different UPCs and one or more different product attributes, e.g., different flavoring, products 152-158 are grouped according to one or more similar or common product attributes and presented in shopping list 148 under the generic product family 150. Shopping list 148 includes a single entry for the yogurt product family 150 instead of individual entries for each flavor of yogurt identified by consumer 42 for purchase. Consumer 42 can make quick reference to the yogurt product family 150 while on the premises of retailers 46-50 and can select specific yogurt flavors at that time. Consumer 42 can interpret product family 150 with sufficient understanding to make a purchasing decision for one or more of products 152-158.

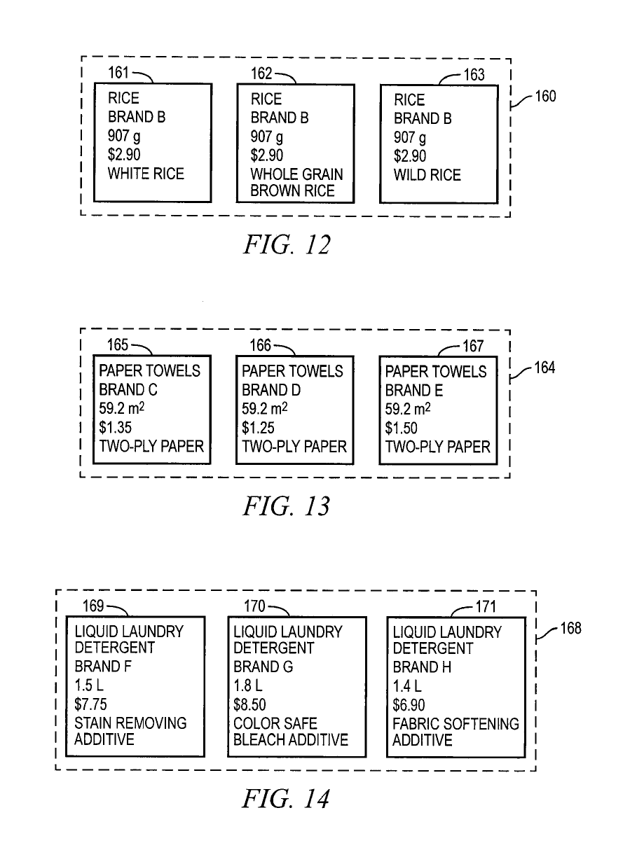

FIG. 12 shows an example of product family 160 containing individual products 161, 162, and 163. Product 161 is a rice product under brand B with package size of 907 g, price of $2.90, and list of attributes or ingredients that include white rice. Product 162 is a rice product under brand B with package size of 907 g, price of $2.90, and list of attributes or ingredients that include whole grain brown rice. Product 163 is a rice product under brand B with package size of 907 g, price of $2.90, and list of attributes or ingredients that include wild rice. Consumer service provider 52 analyzes the product information of products 161-163 and determines that the products differ in the type of rice ingredient and otherwise have common product attributes. Consumer service provider 52 groups products 161-163 into product family 160 with common brand, size, price, or related product attribute. Product family 160 is stored in database 56 for each product 161-163.

When accessing products 161-163 for optimized shopping list 148, database 56 returns product family 160 to simplify the presentation of the products in the optimized shopping list. Although products 161-163 have different UPCs and one or more different product attributes, e.g., different type of rice, products 161-163 are grouped according to one or more similar or common product attributes and presented in shopping list 148 under the generic product family 160. Shopping list 148 includes a single entry for the rice product family 160 instead of individual entries for each type of rice identified by consumer 42 for purchase. Consumer 42 can make quick reference to the rice product family 160 while on the premises of retailers 46-50 and can select specific types of rice at that time. Consumer 42 can interpret product family 160 with sufficient understanding to make a purchasing decision for one or more of products 161-163.

FIG. 13 shows product family 164 containing individual products 165, 166, and 167. Product 165 is a roll of paper towels product under brand C with package size of 59.2 meters² (m²), price of $1.35, and list of attributes that include two-ply paper. Product 166 is a roll of paper towels product under brand D with package size of 59.2 m², price of $1.25, and list of attributes that include two-ply paper. Product 167 is a roll of paper towels product under brand E with package size of 59.2 m², price of $1.50, and list of attributes that include two-ply paper. Consumer service provider 52 analyzes the product information of products 165-167 and determines that the products differ in brand and price and otherwise have common product attributes. Consumer service provider 52 groups products 165-167 into product family 164 with related brands C-E, size, and price range of $1.25-1.50. Product family 164 is stored in database 56 for each product 165-167.

When accessing products 165-167 for optimized shopping list 148, database 56 returns product family 164 to simplify the presentation of the products in the optimized shopping list. Although products 165-167 have different UPCs and one or more different product attributes, e.g., different brand and price, products 165-167 are grouped according to one or more similar or common product attributes and presented in shopping list 148 under the generic product family 164. Shopping list 148 includes a single entry for the roll of paper towels product family 164 instead of individual entries for each brand and price identified by consumer 42 for purchase. Consumer 42 can make quick reference to the roll of paper towels product family 164 while on the premises of retailers 46-50 and can select a specific brand and price at that time. Consumer 42 can interpret product family 164 with sufficient understanding to make a purchasing decision for one or more of products 165-167.

FIG. 14 shows product family 168 containing individual products 169, 170, and 171. Product 169 is a liquid laundry detergent product under brand F with package size of 1.5 liters (L), price of $7.75, and list of attributes that include a stain removing additive. Product 170 is a liquid laundry detergent product under brand G with package size of 1.8 L, price of $8.50, and list of attributes that include a color safe bleach additive. Product 171 is a liquid laundry detergent product under brand H with package size of 1.4 L, price of $6.90, and list of attributes that include a fabric softening additive. Consumer service provider 52 analyzes the product information of products 169-171 and determines that the products differ in brand, size, price, and type of additive. Consumer service provider 52 groups products 169-171 into product family 168 with related brands F-H, size range of 1.4-1.8 L, price range of $6.90-8.50, and additives of stain removing, color safe bleach, or fabric softening. Product family 168 is stored in database 56 for each product 169-171.

When accessing products 169-171 for optimized shopping list 148, database 56 returns product family 168 to simplify the presentation of the products in the optimized shopping list. Although products 169-171 have different UPCs and one or more different product attributes, e.g., different brand, size, price, and type of additive, products 169-171 are grouped according to one or more similar or common product attributes and presented in shopping list 148 under the generic product family 168. Shopping list 148 includes a single entry for the liquid laundry detergent product family 168 instead of individual entries for each type of additive identified by consumer 42 for purchase. Consumer 42 can make quick reference to the liquid laundry detergent product family 168 while on the premises of retailers 46-50 and can select specific brand, size, price, and type of additive at that time. Consumer 42 can interpret product family 168 with sufficient understanding to make a purchasing decision for one or more of products 169-171.

Consumer service provider 52 can group similar or related products into product families with or without the UPC. Consumer service provider 52 searches database 56 and compares the product information for each individual product to identify similar or common attributes. Products with common attributes are grouped together as a product family related by one or more product attributes, e.g., brand, size, price, ingredient, or additive, and differ by one or more product attributes. When accessing products 169-171 for optimized shopping list 148, database 56 returns the product family 168 which is presented as an entry on optimized shopping list 148 to simplify and organize multiple related products. Consumer 42 can interpret the product family with sufficient understanding to make a purchasing decision for one or more of the products within the product family.

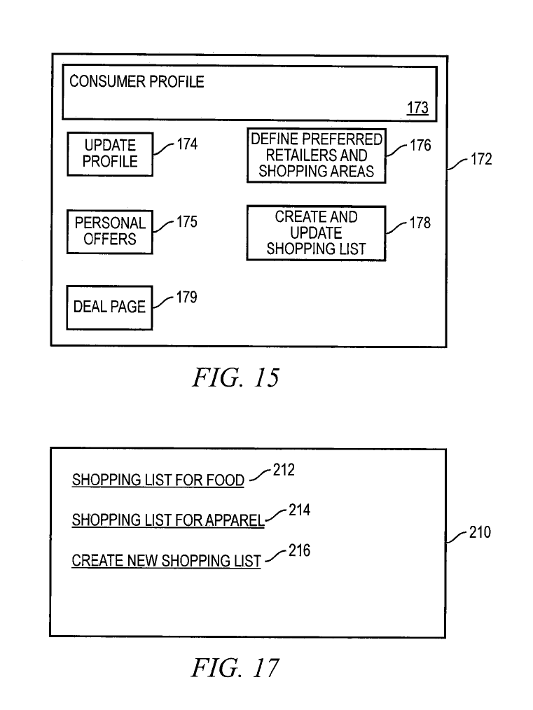

Assume consumer 42 has logged-in to consumer service provider 52 through webpage 116. Consumer 42 is presented with a home page 172, as shown in FIG. 15, to launch a variety of operations and functions using one or more webpages. Block 173 shows the present consumer profile, including name, address, email address, consumer photograph, and other information. The consumer can change personal information and otherwise update the profile in block 174. The consumer can access personal incentives and other offers in block 175. The consumer can define preferred retailers and shopping areas in block 176, create and update one or more shopping lists in block 178, and access an individualized marketing presentation tool or deal page in block 179.

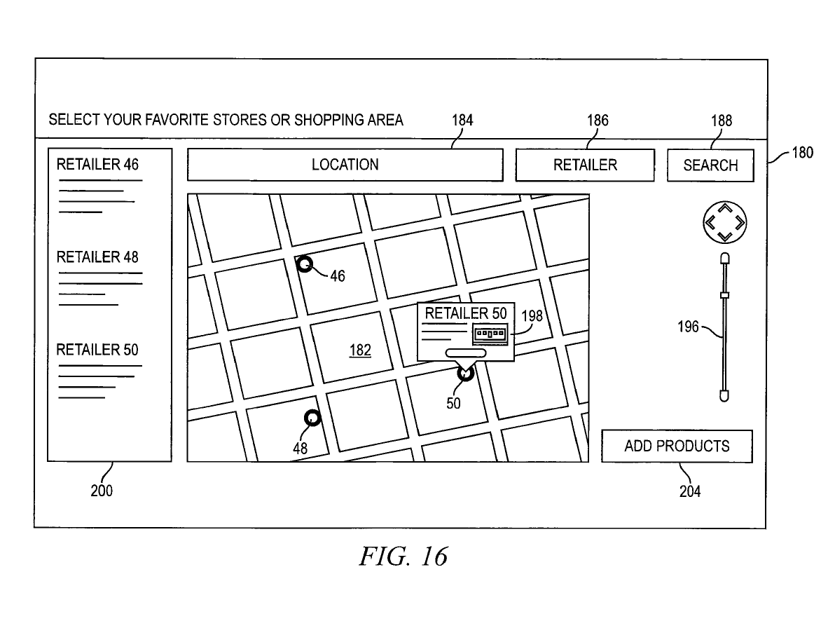

Under the define preferred retailers and shopping areas block 176, personal assistant engine 54 presents webpage 180 with a local map 182, as shown in FIG. 16. A location can be entered in block 184, and retailer name, retailer type, or retailer chain can be entered in block 186. Database 56 contains the name, type, description, and location of retailers nationwide. Consumer 42 presses search button 188 to search database 56 for local retailers according to the location and retailer search pattern in blocks 184-186. The local retailers 46, 48, and 50 matching the search criteria are displayed on map 182. The resolution of map 182 can be adjusted, i.e., zoom in or zoom out, from street level view to a national view with sliding scale 196. Consumer 42 can view additional information about each retailer by hovering the mouse pointer over the retailer location identifier on map 182. For example, pop-up box 198 shows an image, address, phone number, retailer type, retailer website, operating hours, description, and consumer rating and comments of retailer 50. Webpage 180 can provide a button to select all retailers, types of retailers, retailers by tradename, or individual retailers. In this case, consumer 42 searches for grocery retailers and selects retailers 46-50 that he or she would be willing to patronize by individually clicking on the retailer location identifiers 46-50 on map 182. An image, address, phone number, retailer type, retailer website, operating hours, description, and consumer rating and comments of the selected retailers 46-50 are displayed in block 200.

Consumer 42 can also specify all retailers or a selected group of retailers within a geographical shopping area with defined boundaries. The boundaries can be a city, zip code, named roadways, or given number of miles radius to the consumer's address. Consumer 42 can also draw a box on map 182 with the mouse to define the boundaries of the preferred geographical shopping area. The search for retailers would then be limited to the preferred geographical shopping area.

Once the preferred retailers 46-50 or geographical shopping areas are identified, consumer 42 clicks on add products button 204 to create a shopping list of products of interest or need with product attributes weighted by consumer preference. Consumer 42 can also select block 178 in FIG. 15 to create or update a shopping list of products of interest or need with product attributes weighted by consumer preference.

Consumers can create a new shopping list or update an existing shopping list by entering, modifying, or deleting products through one or more webpages, or by mobile app. A plurality of shopping lists can be segregated by type of items, e.g., different shopping lists for food items, household items, apparel, books, and auto parts. A plurality of shopping lists can be segregated by household member, e.g., different shopping lists for each spouse, child, or other member of the household. The shopping list can be aggregated for all items needed by the entire household. In webpage 210 of FIG. 17, personal assistant engine 54 presents link 212 to an existing shopping list for food items and link 214 to an existing shopping list for apparel, as well as link 216 to create a new shopping list. Consumer 42 selects a link to add, delete, or modify the shopping list.

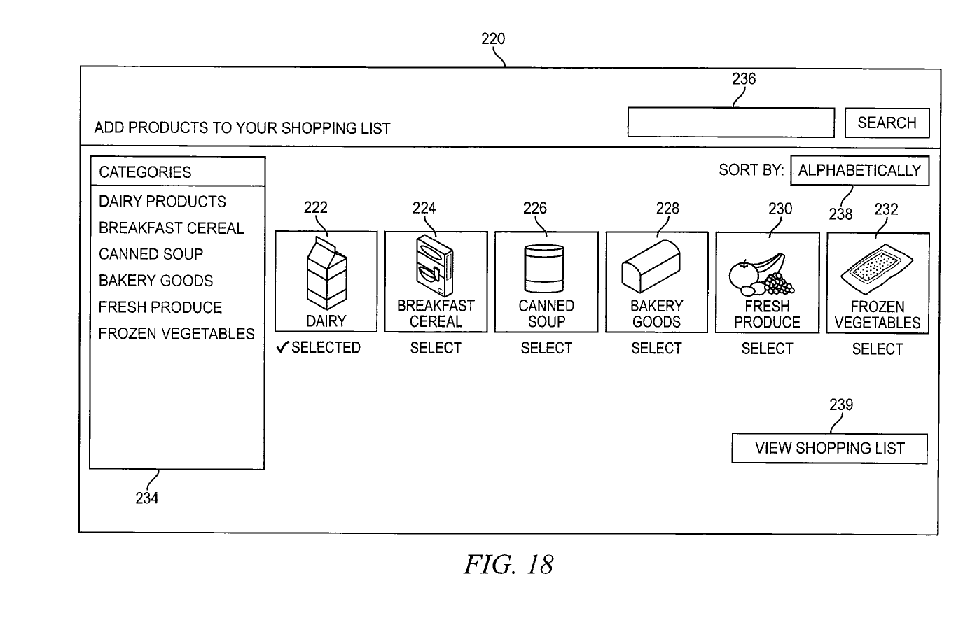

As an illustration of links 212-216, FIG. 18 shows webpage 220 presenting categories of food items. A category is presented for each type of food item. For example, block 222 with corresponding select button is presented for dairy products or dairy product family (DP), block 224 with corresponding select button is presented for breakfast cereal or breakfast cereal family (BC), block 226 with corresponding select button is presented for canned soup or canned soup family (CS), block 228 with corresponding select button is presented for bakery goods or bakery goods family (BG), block 230 with corresponding select button is presented for fresh produce or fresh produce family (FP), and block 232 with corresponding select button is presented for frozen vegetables or frozen vegetables family (FV). A list of categories of food items is also presented in block 234. Block 236 with adjacent search button enables consumer 42 to search for other categories or specific food items. Block 238 enables consumer 42 to sort the categories of food by cost, frequency of purchase, alphabetically, or other convenient attribute.

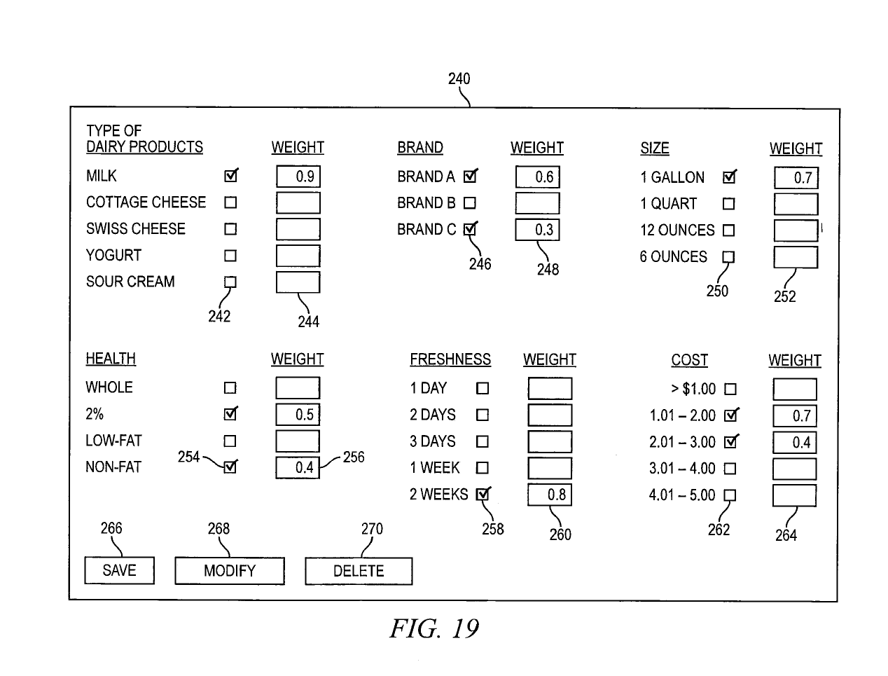

Consumer 42 clicks on the select button corresponding to a category of food item. In the present example, consumer 42 clicks the select button for block 222 to choose attributes and weighting factors or preference levels for dairy products or dairy products family. The available attributes for dairy products or dairy products family are presented in a pop-up window on webpage 220 or on a different webpage. FIG. 19 shows pop-up window 240 overlaying webpage 220 with attributes for type of dairy product, brand, size, health, freshness, and cost. Each attribute has an associated consumer-defined weighting factor for relative importance to the consumer. For example, the attributes for type of dairy product include milk, cottage cheese, Swiss cheese, yogurt, and sour cream. Consumer 42 can select one or more attributes under the type of dairy product by clicking on boxes 242. A checkmark appears in the box 242 selected by consumer 42. Consumer 42 can enter a weighting value or indicator in block 244 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 244 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 240, consumer selects milk under type of dairy product and assigns a weighting factor of 0.9. Consumer 42 considers milk to be an important type of dairy product to be added to the shopping list.

In pop-up window 240, the attributes for brand include brand A, brand B, and brand C. A brand option is provided for each type of dairy product or for the selected type of dairy product. Consumer 42 can select one or more attributes under brand by clicking on boxes 246. A checkmark appears in the box 246 selected by consumer 42. Consumer 42 can enter a weighting value or indicator in block 248 corresponding to the importance of the selected attribute. The weighting factor can be a numeric value, e.g., 0.0-0.9. Alternatively, block 248 includes a sliding scale to select a relative value for the weighting factor. In the present pop-up window 240, consumer selects brand A with a weighting factor of 0.6 and brand C with a weighting factor of 0.3 for the selected milk attribute. Consumer 42 considers either brand A or brand C to be acceptable, but brand A is preferred over brand C as indicated by the relative weighting factors. The weighting factors associated with different brands allow consumer 42 to assign preference levels to acceptable brand substitutes.

The attributes for size include 1 gallon, 1 quart, 12 ounces, and 6 ounces. A size option is provided for each type of dairy product or for the selected type of dairy product. Consumer 42 can select one or more attributes under size by clicking on boxes 250. A checkmark appears in the box 250 selected by consumer 42. Consumer 42 can enter a weighting value or indicator in block 252 corresponding to the importance of the selected attribute. The weighting factor can be a numeric value, e.g., 0.0-0.9. In the present pop-up window 240, consumer selects 1 gallon with a weighting factor of 0.7 for the selected milk attribute.

The attributes for health include whole, 2%, low-fat, and non-fat. A health option is provided for each type of dairy product or for the selected type of dairy product. Consumer 42 can select one or more attributes under health by clicking on boxes 254. A checkmark appears in the box 254 selected by consumer 42. Consumer 42 can enter a weighting value or indicator in block 256 corresponding to the importance of the selected attribute. The weighting factor can be a numeric value, e.g., 0.0-0.9. In the present pop-up window 240, consumer selects 2% with a weighting factor of 0.5 and non-fat with a weighting factor of 0.4 for the selected milk attribute. Consumer 42 considers either 2% milk or non-fat milk to be acceptable, but 2% milk is preferred over non-fat as indicated by the relative weighting factors. The weighting factors associated with different health attributes allow consumer 42 to assign preference levels to acceptable health attribute substitutes.

The attributes for freshness include 1 day old, 2 days old, 3 days old, 1 week to expiration, or 2 weeks to expiration. A freshness option is provided for each type of dairy product or for the selected type of dairy product. Consumer 42 can select one or more attributes under freshness by clicking on boxes 258. A checkmark appears in the box 258 selected by consumer 42. Consumer 42 can enter a weighting value or indicator in block 260 corresponding to the importance of the selected attribute. The weighting factor can be a numeric value, e.g., 0.0-0.9. In the present pop-up window 240, consumer selects 2 weeks to expiration with a weighting factor of 0.8 for the selected milk attribute.

The attributes for cost include less than $1.00, $1.01-2.00, $2.01-3.00, $3.01-4.00, or $4.01-5.00. Consumer 42 can select one or more attributes under cost by clicking on boxes 262. A checkmark appears in the box 262 selected by consumer 42. Consumer 42 can enter a weighting value or indicator in block 264 corresponding to the importance of the selected attribute. The weighting factor can be a numeric value, e.g., 0.0-0.9. In the present pop-up window 240, consumer selects $1.01-2.00 with a weighting factor of 0.7 and $2.01-3.00 with a weighting factor of 0.4 for the selected milk attribute. Consumer 42 is willing to pay either $1.01-2.00 or $2.01-3.00, but would prefer to pay $1.01-2.00 as indicated by the relative weighting factors.

Once the consumer-defined attributes and weighting factors for milk are selected, consumer 42 clicks on save button 266 to record the configuration in database 56. The consumer-defined attributes and weighting factors for milk can be modified with modify button 268 or deleted with delete button 270 in pop-up window 240.

Consumer 42 can add, delete, or modify additional types of dairy products, such as cottage cheese, Swiss cheese, yogurt, and sour cream, in a similar manner as described for milk in FIG. 19. For each type of dairy product, consumer 42 selects one or more brand attributes and associated weighting factors, size attributes and weighting factors, health attributes and weighting factors, freshness attributes and weighting factors, and cost attributes and weighting factors. For each type of dairy product, consumer 42 clicks on save button 266 to record the weighted attribute configuration in database 56. Consumer 42 can also click on modify button 268 or delete button 270 to change or cancel a previously entered product configuration.

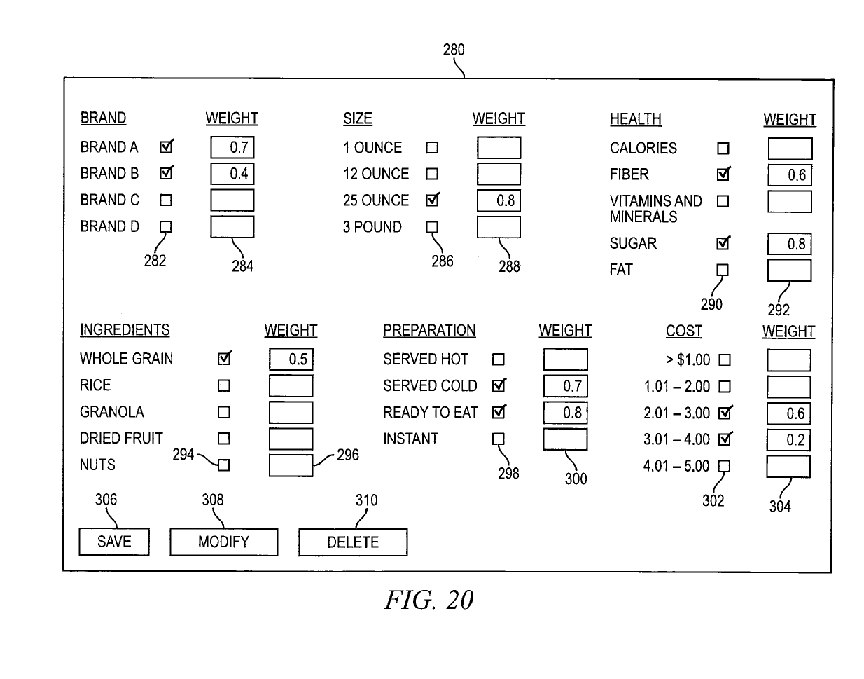

Once the attributes and weighting factors for all dairy products are defined by consumer preference, consumer 42 returns to FIG. 18 to make selections for the next product category. In the present example, consumer 42 clicks the select button for block 224 to choose attributes and weighting factors for breakfast cereal or breakfast cereal family. The available attributes for breakfast cereal products are presented in a pop-up window on webpage 220 or on a different webpage. FIG. 20 shows pop-up window 280 overlaying webpage 220 with attributes for brand, size, health, ingredients, preparation, and cost. Each attribute has an associated consumer-defined weighting factor for relative importance to the consumer. For example, the attributes for brand include brand A, brand B, brand C, and brand D. Consumer 42 can select one or more attributes under brand by clicking on boxes 282. A checkmark appears in the box 282 as selected by consumer 42. Consumer 42 can enter a weighting value or indicator in block 284 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 284 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 280, consumer selects brand A with a weighting factor of 0.7 and brand B with a weighting factor of 0.4 for the selected brand attribute. Consumer 42 considers either brand A or brand B to be acceptable, but brand A is preferred over brand B as indicated by the relative weighting factors. The weighting factors associated with different brands allow consumer 42 to assign preference levels to acceptable brand substitutes.

The attributes for size include 1 ounce, 12 ounce, 25 ounce, and 3 pound. Consumer 42 can select one or more attributes under size by clicking on boxes 286. A checkmark appears in the box 286 selected by consumer 42. Consumer 42 can enter a weighting value or indicator in block 288 corresponding to the importance of the selected attribute. The weighting factor can be a numeric value, e.g., 0.0-0.9. In the present pop-up window 280, consumer selects 25 ounce size with a weighting factor of 0.8.

The attributes for health include calories, fiber, vitamins and minerals, sugar content, and fat content. Health attributes can be given in numeric ranges. Consumer 42 can select one or more attributes under health by clicking on boxes 290. A checkmark appears in the box 290 selected by consumer 42. Consumer 42 can enter a weighting value or indicator in block 292 corresponding to the importance of the selected attribute. The weighting factor can be a numeric value, e.g., 0.0-0.9. In the present pop-up window 280, consumer selects fiber with a weighting factor of 0.6 and sugar content with a weighting factor of 0.8. Consumer 42 considers fiber and sugar content with numeric ranges to be important nutritional attributes according to the relative weighting factors.

The attributes for ingredients include whole grain, rice, granola, dried fruit, and nuts. Consumer 42 can select one or more attributes under ingredients by clicking on boxes 294. A checkmark appears in the box 294 selected by consumer 42. Consumer 42 can enter a weighting value or indicator in block 296 corresponding to the importance of the selected attribute. The weighting factor can be a numeric value, e.g., 0.0-0.9. In the present pop-up window 280, consumer selects whole grain with a weighting factor of 0.5.

The attributes for preparation include served hot, served cold, ready-to-eat, and instant. Consumer 42 can select one or more attributes under preparation by clicking on boxes 298. A checkmark appears in the box 298 selected by consumer 42. Consumer 42 can enter a weighting value or indicator in block 300 corresponding to the importance of the selected attribute. The weighting factor can be a numeric value, e.g., 0.0-0.9. In the present pop-up window 280, consumer selects served cold with a weighting factor of 0.7 and ready-to-eat with a weighting factor of 0.8.

The attributes for cost include less than $1.00, $1.01-2.00, $2.01-3.00, $3.01-4.00, or $4.01-5.00. Consumer 42 can select one or more attributes under cost by clicking on boxes 302. A checkmark appears in the box 302 selected by consumer 42. Consumer 42 can enter a weighting value or indicator in block 304 corresponding to the importance of the selected attribute. The weighting factor can be a numeric value, e.g., 0.0-0.9. In the present pop-up window 280, consumer selects $2.01-3.00 with a weighting factor of 0.6 and $3.01-4.00 with a weighting factor of 0.2. Consumer 42 is willing to pay either $2.01-3.00 or $3.01-4.00, but would prefer to pay $2.01-3.00 as indicated by the relative weighting factors.

Once the consumer-defined attributes and weighting factors for breakfast cereal are selected, consumer 42 clicks on save button 306 to record the configuration in database 56. The consumer-defined attributes and weighting factors for breakfast cereal can be modified with modify button 308 or deleted with delete button 310 in pop-up window 280.

Consumer 42 can add, delete, or modify other breakfast cereals in a similar manner as described in FIG. 20. For each breakfast cereal, consumer 42 selects one or more brand attributes and associated weighting factors, size attributes and weighting factors, health attributes and weighting factors, ingredients attributes and weighting factors, preparation attributes and weighting factors, and cost attributes and weighting factors. For each breakfast cereal, consumer 42 clicks on save button 306 to record the weighted attribute configuration in database 56. Consumer 42 can also click on modify button 308 or delete button 310 to change or cancel a previously entered product configuration.

Consumer 42 makes selections of attributes and weighting factors canned soup or canned soup family in block 226, bakery goods or bakery goods family in block 228, fresh produce or fresh produce family in block 230, and frozen vegetables or frozen vegetables family in block 232, as well as other food categories, in a similar manner as described in FIGS. 19 and 20. The food categories can also be selected from block 234 in FIG. 18. The consumer-defined product attributes and weighting factors for each food category are stored in database 56. The attributes and weighting factors as selected by consumer 42 in each of the food categories constitute an initial or generally defined list of products of interest or need by the consumer.

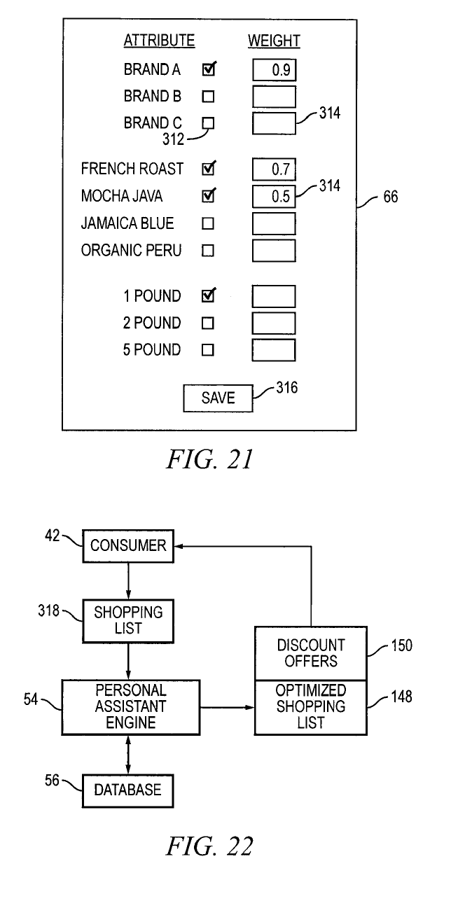

In another embodiment, consumer 42 can record product attributes and weighting factors by mobile app. When patronizing a retailer, consumer 42 can record a product of interest or need by scanning the UPC on the shelf or product itself with cell phone 66. The UPC is transmitted to consumer service provider 52 and decoded. The product attributes are retrieved from database 56, transmitted back to consumer 42, and displayed on cell phone 66. For example, if consumer 42 scans a particular ground coffee, the UPC identifies it as brand A, French roast flavor, and 1 pound size for the ground coffee, as shown in FIG. 21. Personal assistant engine 54 provides other ground coffee attributes, e.g., other brands, flavors, and sizes. Consumer 42 can select product attributes by clicking on boxes 312, i.e., to indicate a willingness to consider similar products, and assign weighting factors for the product attributes in boxes 314. Consumer 42 selects brand A and assigns a weighting factor. Consumer 42 also checks the attributes to accept French roast and mocha Java flavors with corresponding weighting factors. No weight is assigned to the size attribute. The product attributes and weighting factors are transmitted back to consumer service provider 52 and stored in database 56 to update the consumer's shopping list by clicking on save button 316. The mobile app on cell phone 66 can also decode the UPC.

Many cell phones 66 contain a global positioning system (GPS) device to determine the location of consumer 42 while in the premises of a retailer. Knowledge of the present location of consumer 42 provides a number of advantages. For example, consumer service provider 52 can give directions to consumer 42 of the shelf location of each product on optimized shopping list 148. With RF ID tag attached to products, cell phone 66 can display directional information such as text or arrows to guide consumer 42 to the product location. Many retailers also offer in-store locator systems in communication with cell phone 66 to assist with finding specific products.

In FIG. 22, personal assistant engine 54 stores shopping list 318 with weighted product attributes of each specific consumer in database 56 for future reference and updating. Personal assistant engine 54 can also store prices, product descriptions, names and locations of the retail stores selling the products, offer histories, purchase histories, as well as various rules, policies and algorithms. The individual products in the shopping list can be added or deleted and the weighted product attributes can be changed by the consumer. The shopping list entered into personal assistant engine 54 is specific for each consumer and allows consumer service provider 52 to track specific products and preferred retailers selected by the consumer.

The consumer can also identify a specific preferred retailer as an attribute with an assigned preference level based on convenience and personal experience. The consumer may assign value to shopping with a specific retailer because of specific products offered by that store, familiarity with the store layout, good consumer service experiences, or location that is convenient on the way home from work, picking up the children from school, or routine weekend errand route.

Given the consumer-generated initial list of products 318 as defined in FIGS. 18-21, personal assistant engine 54 executes a comparative shopping service to optimize the shopping list and determine which products should be purchased from which retailers on which day to maximize the value to the consumer as defined by the consumer profile and list of products of interest or preferred products with weighted attributes. Personal assistant engine 54 also generates for each specific consumer an optimized shopping list 148 with discounted offers 150, as shown in FIGS. 8 and 22, by considering each line item of the consumer's shopping list 318 from webpage 220 and pop-up windows 240 and 280 and reviewing retailer product information in database 56 to determine how to best align each item to be purchased with the available products from the retailers. For example, consumer 42 wants to purchase dairy products and has provided shopping list 318 with preference levels for weighted product attributes for milk and other dairy products that are important to his or her purchasing decision. Database 56 contains dairy product descriptions, dairy product attributes, and pricing for each retailer 46-50. Personal assistant engine 54 reviews the attributes of dairy products and product families offered by each retailer 46-50, as stored in database 56. The more specific the consumer-defined attributes, the narrower the search field but more likely the consumer will get the preferred product or product family. The less specific the consumer-defined attributes, the wider the search field and more likely the consumer will get the most choices and best pricing.

The product attributes of each dairy product and product family for retailers 46-50 in database 56 are compared to the consumer-defined weighted product attributes in shopping list 318 by personal assistant engine 54. For example, the available dairy products and product families from retailer 46 are retrieved and compared to the weighted attributes of consumer 42. Likewise, the available dairy products and product families from retailer 48 are retrieved and compared to the weighted attributes of consumer 42, and the available dairy products and product families from retailer 50 are retrieved and compared to the weighted attributes of consumer 42. Consumer 42 wants milk under brand A with a weighting level of 0.6 or milk under brand C with a weighting level of 0.3. Those retailers with brand A of milk or brand C of milk receive credit or points weighted by the preference level for meeting the consumer's attribute. Otherwise, the retailers receive no credit or points, or less credit or points, because the product attribute does not align or is less aligned with the consumer weighted attribute. Consumer 42 wants 1 gallon size with a preference level of 0.7. Those retailers with 1 gallon size milk receive credit or points weighted by the preference level for meeting the consumer's attribute. Otherwise, the retailers receive no credit or points, or less credit or points, because the product attribute does not align or is less aligned with the consumer weighted attribute. Consumer 42 wants 2% milk with a preference level of 0.5 or non-fat milk with a preference level of 0.4. Those retailers with 2% milk or non-fat milk receive credit or points weighted by the preference level for meeting the consumer's attribute. Otherwise, the retailers receive no credit or points, or less credit or points, because the product attribute does not align or is less aligned with the consumer weighted attribute. Consumer 42 wants 2 weeks to expiration for milk with a preference level of 0.8. Those retailers with fresh milk (at least 2 weeks to expiration) receive credit or points weighted by the preference level for meeting the consumer's attribute. Those retailers with milk set to expire in less than 2 weeks receive less credit or points because the product attribute does not align or is less aligned with the consumer weighted attribute. Consumer 42 wants milk at a price $1.01-2.00 with a preference level of 0.7, or milk at a price $2.01-3.00 with a preference level of 0.4. Those retailers with the lower net price (regular price minus discount for consumer 42) receive the most credit or points weighted by the preference level for being the closest to meeting the consumer's attribute. Those retailers with higher net prices receive less credit or points because the product attribute does not align or is less aligned with the consumer weighted attribute.

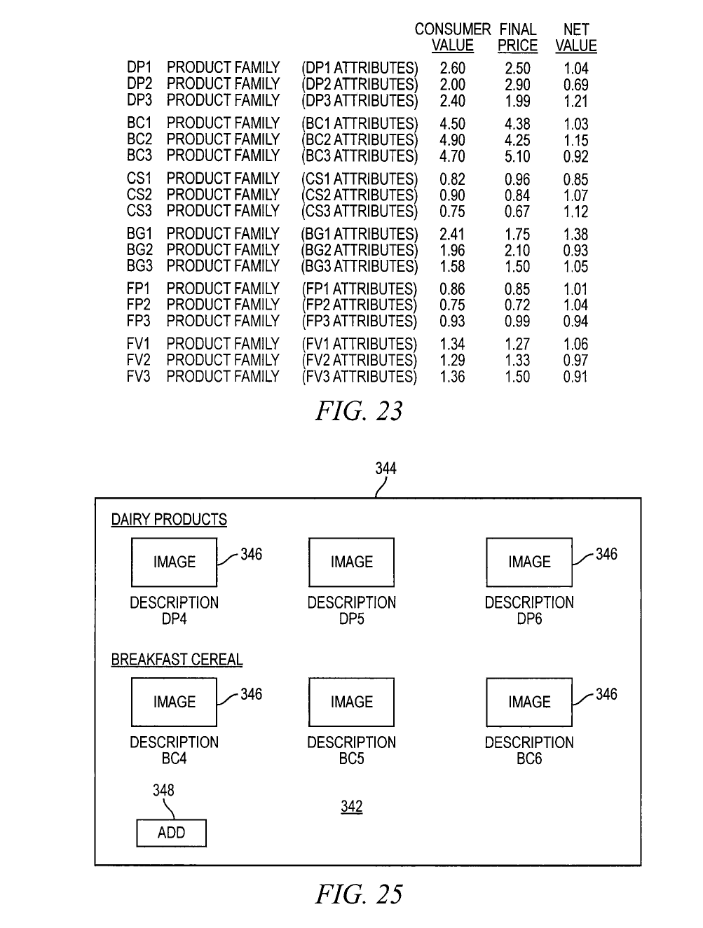

FIG. 23 shows three possible choices for the consumer requested dairy product (milk) from retailers 46-50, as ascertained from database 56. The dairy product is presented under a product family, as described in FIGS. 10-14. Dairy product family DP1 from retailer 46 is shown with DP1 product family attributes, e.g., brand A, 1 gallon, 2%, 2 weeks to expiration freshness, and discounted price of $2.50 (regular price of $2.90 less 0.40 default discounted offer from retailer 46). The “Consumer Value” column shows the value to consumer 42 based on alignment of the DP1 product family attributes and the weighted product attributes as defined by the consumer. The DP1 product family gets attributes points AP1 for brand A, attributes points AP2 for 1 gallon, attributes points AP3 for 2%, attributes points AP4 for 2 weeks to expiration freshness, and attributes points AP5 for discounted price of $2.50. The consumer value (CV) is a summation of assigned attributes points for alignment between the product attributes and the weighted product attributes as defined by the consumer times the preference level for the weighted product attributes, i.e., AP1*0.6+AP2*0.7+AP3*0.5+AP4*0.8+AP5*0.4. Assume that the DP1 product family gets CV of $2.60 USD. The consumer value CV is given in a recognized monetary denomination, such as US dollar (USD), Canadian dollar, Australian dollar, Euro, British pound, Deutsche mark, Japanese yen, and Chinese yuan.

Consumer value CV can also be determined by equation (1) as follows:

CV=CV_{b}Πₐ(Mₐ) (1)
where: CV_{b} is a baseline product value of the product category, and
   Mₐ is the product attribute value to the consumer for product attribute a expressed as (1+x %), where x is a percentage increase in value of the product to the consumer having the attribute a with respect to products having no product attribute a.

The “Final Price” column shows the final price (FP) offered to the consumer, i.e., regular price less the default discount from retailer 46 ($2.90−0.40=2.50). The “Net Value” column is the net value or normalized value (NV) of the DP1 product family to consumer 42. In one embodiment, the net value is the consumer value normalized by the final price, i.e., NV=CV/FP. Alternatively, the net value is determined by NV=(CV−FP)/CV. Using the first normalizing definition, NV=2.60/2.50=1.04. The consumer value CV is greater than the final price FP offered by retailer 46, including the default discount. The net value NV to consumer 42 is greater than one (CV greater than FP) so the DP1 product family is a possible choice for the consumer. Using the second normalizing definition, NV=(2.60−2.50)/2.60=+0.04. The net value NV to consumer 42 is positive so the DP1 product family may be a good choice for the consumer. Consumer 42 is likely to buy the DP1 product family because the product attributes align or match reasonably well with the consumer weighted attributes, taking into account the discounted offer. A net value NV greater than one or positive indicates that retailer 46 may receive a positive purchasing decision from consumer 42 because the consumer value CV greater than the final price FP. Personal assistant engine 54 may recommend the DP2 product family to consumer 42 in optimized shopping list 148.

Dairy product family DP2 (milk) from retailer 48 is shown with DP2 product family attributes, e.g., brand B, 1 gallon, non-fat, 1 week to expiration in freshness, and pricing of $2.90 (regular price of $2.90 with no discounted offer from retailer 48). The DP2 product family gets no or minimal attributes points AP6 for brand B, attributes points AP7 for 1 gallon size, attribute points AP8 for non-fat, no or minimal attribute points AP9 for 1 week to expiration in freshness, and attributes points AP10 for the $2.90 price. The consumer value is AP7*0.7+AP8*0.4+AP9*0.0+AP10*0.4. Assume that the DP2 product family gets CV of $2.00 USD. The final price FP is the regular price less the default discount from retailer 48 ($2.90). Using the first normalizing definition, NV=2.00/2.90=0.69. The net value NV to consumer 42 is less than one so the DP2 product family will not be a good choice for the consumer. Using the second normalizing definition, NV=(2.00−2.90)/2.00=−0.45. The net value NV to consumer 42 is negative so the DP2 product family will not be a good choice for the consumer. Consumer 42 is likely not to buy the DP2 product family because the product attributes do not align or match well with the consumer weighted attributes, taking into account the discounted offer. A net value NV less than one or negative indicates that retailer 46 would likely not receive a positive purchasing decision from consumer 42. Personal assistant engine 54 should not recommend the DP2 product family to consumer 42 in optimized shopping list 148.

Dairy product family DP3 (milk) from retailer 50 is shown with DP3 product family attributes, e.g., brand C, 1 gallon size, 2%, 2 weeks to expiration in freshness, and pricing of $1.99 (regular price of $2.75 less 0.76 discounted offer from retailer 50). The DP3 product family gets attributes points AP11 for brand C, attributes points AP12 for 1 gallon size, attributes points AP13 for 2%, attributes points AP14 for 2 weeks to expiration in freshness, and attributes points AP15 for the $1.99 price. The consumer value is AP11*0.3+AP12*0.7+AP13*0.5+AP14*0.8+AP15*0.7. Assume that the DP3 product family gets CV of $2.40 USD. The final price FP is the regular price less the default discount ($2.75−0.76=1.99). Using the first normalizing definition, NV=2.40/1.99=1.21. The net value NV to consumer 42 is greater than one (CV greater than FP) so the DP3 product family is a possible choice for consumer 42. Using the second normalizing definition, NV=(2.40−1.99)/2.40=+0.17. The net value NV to consumer 42 is positive so the DP3 product family is a possible choice for the consumer. In fact, based on the default discounted offers from retailers 46-50, the net value of the DP3 product family (NV=1.21) or (NV=+0.17) is the highest net value NV, i.e., higher than the net value of the DP1 product family (NV=1.04) or (NV=+0.04) and higher than the net value of the DP2 product family (NV=0.69) or (NV=−0.45). The DP3 product family is placed on optimized shopping list 148. The DP3 product family is the optimal choice for consumer 42 in that if the consumer needs to purchase milk, then DP3 is the product family most closely aligned with the consumer weighted attributes, i.e., highest net value NV, and would likely receive a positive purchasing decision from consumer 42.

The above process is repeated for breakfast cereal product families BC1, BC2, and BC3, canned soup product families CS1, CS2, and CS3, bakery goods product families BG1, BG2, and BG3, fresh produce product families FP1, FP2, and FP3, and frozen vegetable product families FV1, FV2, and FV3 from webpage 220 and pop-up windows 240 and 280 based on the product information in database 56, preference levels for the consumer weighted product attributes, and lowest discount that will result in a positive purchasing decision. The best value product in each food category for consumer 42 is placed on optimized shopping list 148. In the present example, the BC2 product family from retailer 48 (NV=1.15), the CS3 product family from retailer 50 (NV=1.12), the BG1 product family from retailer 46 (NV=1.38), the FP2 product family from retailer 48 (NV=1.04), and the FV1 product family from retailer 46 (NV=1.06) are determined to be the best value product brand for consumer 42 and are placed on optimized shopping list 148. The other products from retailers 46-50 had a net value less than one or a net value greater than one but less than that of the winning retailer.

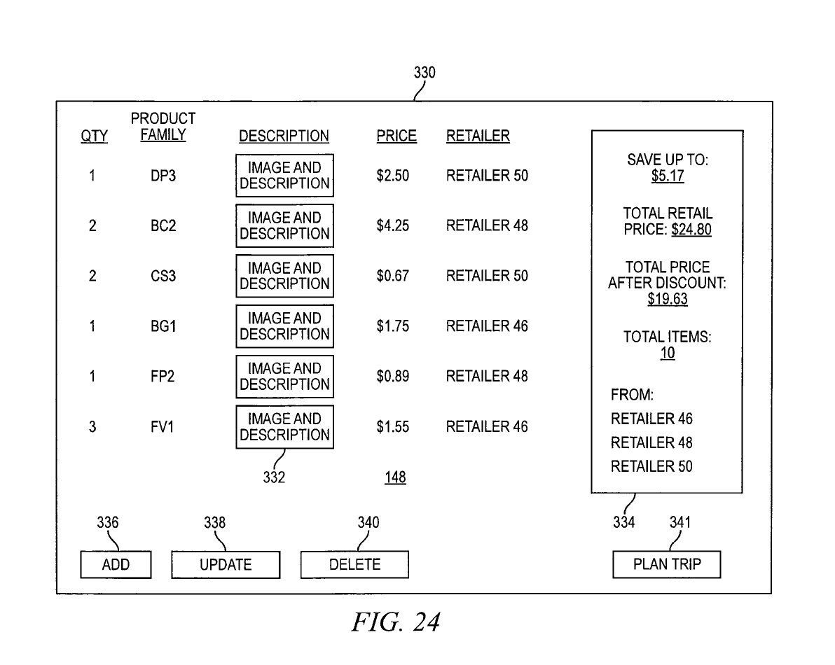

Consumer 42 can view optimized shopping list 148 by clicking on the view shopping list button 239 in FIG. 18. The optimized shopping list 148 is presented to consumer 42 on webpage 330 in FIG. 24. The optimized shopping list 148 includes the preferred products of consumer 42 organized by consumer service provider 52 based on the consumer weighted product attributes and product information from retailers 46-50 in database 56. The highest NV product for items in each food category is displayed with quantity, product name, description field, price, and retailer. According to the above analysis, product family DP3 (milk) is presented with quantity 1, image and detailed description of DP3 in block 332, price, and retailer, as having the highest NV to consumer 42. The image and description of product family DP3 include a photo, package size, package configuration, availability, highest price at any retailer, lowest price at any retailer, average price, discount offer, and other marketing information. Likewise, the product family BC2 is presented with quantity 2, image and detailed description of BC2 in block 332, price, and retailer; the product family CS3 is presented with quantity 2, image and detailed description of CS3 in block 332, price, and retailer; the product family BG1 is presented with quantity 1, image and detailed description of BG1 in block 332, price, and retailer; the product family FP2 is presented with quantity 1, image and detailed description of FP2 in block 332, price, and retailer; and the product family FV1 is presented with quantity 3, image and detailed description of FV1 in block 332, price, and retailer. The optimized shopping list 148 can be presented in a grid arrangement or scrolling vertical or horizontal banner. For each item in optimized shopping list 148 on webpage 330, additional consumer information can be displayed such as price history, health benefits, suggested for season, time to stock up before price increase, and other consumer tips. The image and description field can be enlarged with a pop-up window to show product ingredients, health warnings, manufacturer, and nutrition label.

Webpage 330 also displays in block 334 a “save up to” price of $5.17 as retail price less discounts, total retail price of $24.60, and total price after discounts of $19.63 for all 10 items. The “save up to” value can be based on actual pricing of the retailer or an average or highest local, regional, or national regular pricing. For example, the “save up to” value can be the highest price from any retailer in a region over the past year. A list of the retailers to be patronized (46-50) is also shown in block 334, based on the products contained in optimized shopping list 148. Webpage 330 also provides options to show the consumer weighted product attributes in a pop-up window, similar to FIGS. 19 and 20, by clicking on any image and description block 332. The optimized shopping list 148 can be sorted or organized by cost, frequency of purchase, aisle or location with the retailer, alphabetically, or other convenient attribute. Consumer 42 can modify optimized shopping list 148, as well as the consumer weighted product attributes, with add button 336, update button 338, or delete button 340.

Webpage 330 can present alternate or additional versions of optimized shopping list 148. For example, personal assistant engine 54 can generate a shopping list 342, as shown on webpage 344 of FIG. 25, with the best price, best deal, or other marketing strategy for products across the board, or within one or more food categories. The best deal shopping list 342 can be based on the consumer weighted product attributes, or independent of the consumer weighted product attributes. Webpage 344 shows an image in block 346 and description field for best deal dairy product families DP4, DP5, and DP6, and best deal for breakfast cereal product families BC4, BC5, and BC6. The description field can contain product name, product size, packaging configuration, availability, highest price at any retailer, lowest price at any retailer, average price, retailer, retail price, discount, discounted price, and other marketing information. The image and description field of each best deal product can be enlarged with a pop-up window. The best deal products on shopping list 342 can be added to optimized shopping list 148 with add button 348.

In another embodiment, personal assistant engine 54 can generate an optimized shopping list, similar to FIG. 24, based on historical shopping practices of consumer 42. Personal assistant engine 54 can suggest additional products for an existing optimized shopping list 148 based on historical purchasing patterns of consumer 42. If consumer 42 historically purchases laundry detergent once a month and the item is not on optimized shopping list 148 after more than a month since the last purchase, then personal assistant engine 54 can suggest that laundry detergent be added to the list. Personal assistant engine 54 can generate an optimized shopping list based on favorite products of consumer 42.

In another embodiment, multiple brands and/or retailers for a single product can be placed on optimized shopping list 148. Personal assistant engine 54 can place, say the top two or top three net value brands and/or retailers on optimized shopping list 148, and allow the consumer to make the final selection and purchasing decision. In the above example, the DP3 product family (NV=1.21) could be placed in first position on optimized shopping list 148 and the DP1 product family (NV=1.04) would be in second position on the optimized shopping list.

Another optimized shopping list 148 is generated for consumer 44 by repeating the above process using the preference levels for the weighted product attributes as defined by consumer 44. The optimized shopping list 148 for consumer 44 gives the consumer the ability to evaluate one or more recommended products, each with a discount for consumer 44 to make a positive purchasing decision. The recommended products are objectively and analytically selected from a myriad of possible products from competing retailers according to the consumer weighted attributes. Consumers 42-44 will develop confidence in making a good decision to purchase a particular product from a particular retailer.

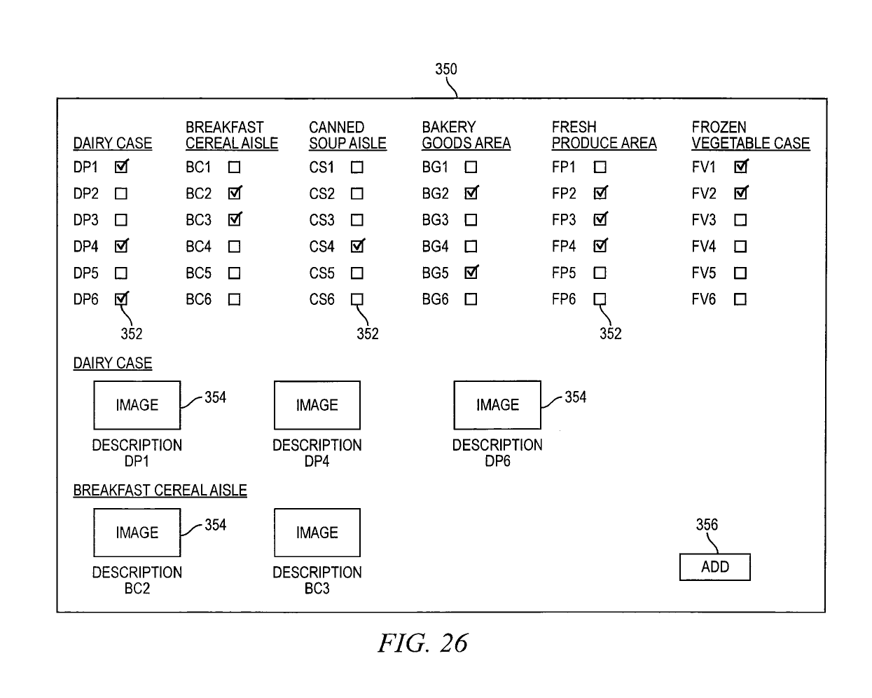

Personal assistant engine 54 can provide a virtual shopping experience for consumer 42. Retailers 46-50 each have a physical layout of the premise with aisles, shelves, end caps, walls, floor displays, dairy cases, wine and spirit cases, frozen cases, meat counters, deli counters, bakery area, fresh produce area, prepared foods counters, and check-out displays. While the specific location of each food area within any given store may differ between retailers, each retailer offers similar products arranged in a logical layout, e.g., dairy products are stocked in the same general area, frozen foods are stocked in the same general area, and so on. FIG. 26 shows webpage 350 with a virtual layout of one or more retailers with virtual aisles or cases for each category of food product. The virtual dairy case presents all dairy product families, i.e., DP1-DP6, for the retailer. The virtual breakfast cereal aisle presents all breakfast cereal product families, i.e., BC1-BC6, for the retailer. The virtual canned soup aisle presents all canned soup product families, i.e., CS1-CS6, for the retailer. The virtual bakery goods area presents all bakery goods product families, i.e., BG1-BG6, for the retailer. The virtual fresh produce area presents all fresh produce product families, i.e., FP1-FP6, for the retailer. The virtual frozen vegetable case presents all frozen vegetable product families, i.e., FV1-FV6, for the retailer. Consumer 42 can select products from the virtual layout by clicking on box 352. The selected products are displayed for each food category with an image in block 354 and description field. The description field can contain product name, product size, packaging configuration, availability, highest price at any retailer, lowest price at any retailer, average price, retailer, retail price, discount, discounted price, and other marketing information. The selected products can be added to optimized shopping list 148 with add button 356.

The product families organized by consumer service provider 52 simplifies optimized shopping list 148 for presentation to consumers 42-44. Consumers 42-44 can interpret the product family with sufficient understanding to make a purchasing decision for one or more of the products within the product family.

In the business transactions between consumers 42-44 and retailers 46-50, consumer service provider 52 plays an important role in terms of increasing sales for the retailer, while providing the consumer with the most value for the money, i.e., creating a win-win scenario. More specifically, consumer service provider 52 operates as an intermediary between special offers and discounts made available by the retailer and distribution of those offers to the consumers.

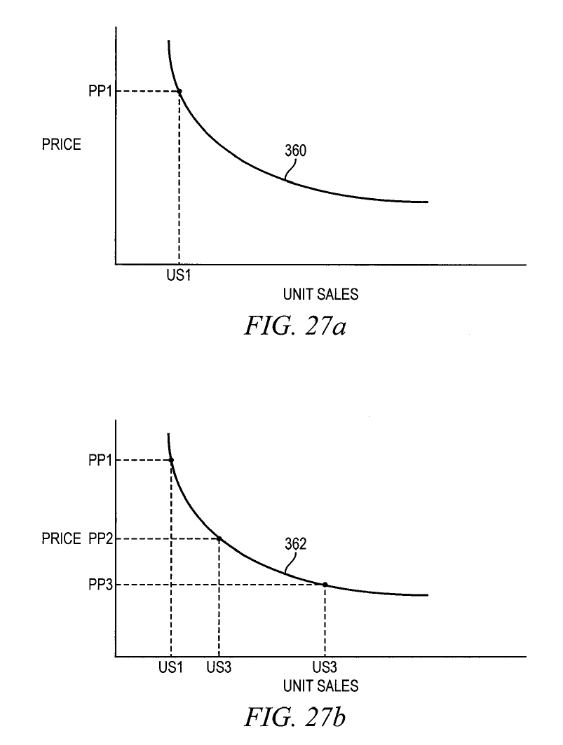

To explain part of the role of consumer service provider 52, first consider demand curve 360 of price versus unit sales, as shown in FIG. 27a. In demand curve 360 for a given product P, as price increases, unit sales decrease and, conversely, as price decreases, unit sales increase. At price point PP1, the unit sales are US1. The revenue attained by the retailer is given as PP1*US1. Thus, using a conventional mass marketing strategy as described in the background, if the retailer offers an across the board discounted offer or sale price PP1 to all consumers, e.g., via a newspaper advertisement, then, according to demand curve 360, the expected unit sales will be US1 and the retailer revenue is PP1*US1. That is, those consumers with a purchasing decision threshold of PP1 will buy product P and those consumers with a purchasing decision threshold less than PP1 will not buy product P. The conventional mass marketing approach has missed the opportunity to sell product P at price points below PP1. The retailer loses potential revenue that could have been earned at lower price points.

Now consider demand curve 362 in FIG. 27b with multiple price points PP1, PP2, and PP3, each capable of generating a profit for the retailer. The number of price points that can be assigned on demand curve 362 differ by as little as one cent, or a fraction of a cent. With a consumer targeted marketing approach, those consumers with a purchasing decision threshold of PP1 will buy product P at that price, those consumers with a purchasing decision threshold of PP2 will buy product P at that price, and those consumers with a purchasing decision threshold of PP3 will buy product P at that price. The retailer now has the potential revenue of PP1*US1+PP2*US2+PP3*US3. Although the profit margins for price points PP2 and PP3 are less than price point PP1, the unit sales US2 and US3 will be greater than unit sales US1. The total revenue for the retailer under FIG. 27b is greater than the revenue under FIG. 27a.

Under the consumer targeted marketing approach, each individual consumer receives a price point with an individualized discounted offer, i.e., PP1, PP2, or PP3, from the retailer for the purchase of product P. The individualized discounted offer is set according to the individual consumer price threshold that will trigger a positive purchasing decision for product P. The task is to determine an optimal pricing threshold for product P associated with each individual consumer and then make that discounted offer available for the individual consumer in order to trigger a positive purchasing decision. In other words, the individualized discounted offer involves consumer C1 being offered price PP1, consumer C2 being offered price PP2, and consumer C3 being offered price PP3 for product P. Each consumer C1-C3 should make the decision to purchase product P, albeit, each with a separate price point set by an individualized discounted offer. Consumer service provider 52 makes possible the individual consumer targeted marketing with the consumer-specific, personalized “one-to-one” offers as a more effective approach for retailers to maximize revenue as compared to the same discounted price for every consumer under mass marketing. Consumer service provider 52 becomes the preferred source of retail information for the consumer, i.e., an aggregator of retailers capable of providing one-stop shopping for many purchasing options. The individualized discounted offers enable market segmentation to the “one-to-one” level with each individual consumer receiving personalized pricing for a specific product.

With respect to pricing, each retailer has two price components: regular price and discounted offers from the regular price that are variable over time and specific to each consumer. The net price to consumer 42 is the regular price less the individualized discounted offer for that consumer. To determine optimal individualized discount needed to achieve a positive consumer purchasing decision for product P from consumer 42, personal assistant engine 54 considers the individualized discounts from each retailer 46-50. In one embodiment, the individualized discount can be a default discount determined by the retailer or personal assistant engine 54 on behalf of the retailer. The default discount is defined to provide a reasonable profit for the retailer as well as reasonable likelihood of attaining the first position on optimized shopping list 148, i.e., the default discounted offer is selected to be competitive with respect to other retailers.

Personal assistant engine 54 generates for each specific consumer an individualized discounted offer 150 for each product or product family on optimized shopping list 148, as shown in FIGS. 8 and 22. The individualized discounted offer is crafted for each individual consumer based on a product specific preference value of the consumer weighted attributes. Each consumer receives an individualized “one-to-one” offer 150. That is, the optimized shopping list for consumer 42 will have an individualized discounted offer 150 for product P1 based on the product specific preference value of the consumer 42 weighted attributes. The optimized shopping list for consumer 44 may have a different individualized discounted offer 150 for the same product P1 based on the product specific preference value of the consumer 44 weighted attributes. The individualized discounted offer 150 should be set to trigger a positive purchasing decision for each consumer. The products that show up on optimized shopping list 148 are the products of interest to the consumer offered at the most valued price.

The optimal discounted offer tipping point (P_{TIP}) for consumer 42 to make a positive purchasing decision between two products can be determined according to P_{TIP}=CV_{K}−CV_{K}*(CV_{I}−P_{I})/CV_{I}, where CV_{K} is the consumer value of product K, CV_{I} is the consumer value of product I, and P_{I} is the price of product I.

The optimized individualized discounted offer is in part a competitive process between retailers. Since the consumer needs to purchase the product from someone, the price tipping point for consumers may involve a comparison of the best available price from competing retailers. In a variation of the previous example, the optimal individualized discounted offer needed to achieve a positive consumer purchasing decision for the product from consumer 42 involves a repetitive process beginning with the regular price, or regular price less the default discount, and then incrementally increasing the individualized discounted offer until the optimal individualized discount or winning retailer is determined. Continuing from the example of FIG. 23, retailer 46 offering dairy product family DP1 currently in second position behind retailer 50 offering dairy product family DP3 and may want to be in first position on optimized shopping list 148. Retailer 46 authorizes personal assistant engine 54 to increase the individualized discounted offer to consumer 42 as necessary to achieve that position. Personal assistant engine 54 increases the individualized discounted offer from retailer 46 by as little as one cent, or fraction of one cent, and recalculates the net value NV to consumer 42. If retailer 46 remains in second position, the discounted offer is incremented again and the net value NV is recalculated. The incremental increases in the individualized discounted offer from retailer 46 continue until retailer 46 achieves first position over retailer 50 on optimized shopping list 148, or until retailer 46 reaches its maximum retailer acceptable discount. The maximum retailer acceptable discounted price is typically determined by the retailer's profit margin. If product P costs $1.50 to manufacture, distribute, and sell, and the regular price is $2.50, then the retailer has at most $1.00 in profit to offer as a discount without creating an operating loss. In this case, the maximum retailer acceptable discounted price is $1.00 or less, depending on how much profit margin the retailer is willing to forego in order to make the sale. In most cases, retailer 46 will not exceed its maximum retailer acceptable discount, as to do so would result in no profit or a loss on the transaction.

If personal assistant engine 54 begins with the regular price for each retailer 46-50, the net value NV is determined for the DP1-DP3 product families based on the final price FP equal to the regular price for the respective products. The occurrence of a net value NV less than one or negative for particular retailers is not dispositive as the individualized discounted offers have not yet been considered. Personal assistant engine 54 may run the net value calculations based on the regular price to determine the retailer with the highest net value NV for consumer 42. The highest net value retailer based on the regular price is tentatively in first position, although the discounted offer optimization process is just beginning. Personal assistant engine 54 makes a first individualized discounted offer on behalf of each retailer 46-50 and calculates the net value NV for consumer 42, as described above, for each of the DP1-DP3 product families. The initial individualized discounted offer can be the default discount for the retailer, or a smaller incremental discount as little as one cent or fraction of one cent. Based on the initial individualized discounted offer, one retailer is determined to provide the highest net value NV for consumer 42. The individualized discounted offer optimization may stop there and the winning retailer will be in first position on optimized shopping list 148. Alternatively, retailers 46-50 authorize personal assistant engine 54 to increment their respective individualized discounted offer to consumer 42. The retailers that did not attain the coveted first position on optimized shopping list 148 after the initial individualized discount may want to continue bidding for that spot. Those retailers that choose to can incrementally increase their respective individualized discounted offer and personal assistant engine 54 recalculates the net value NV to consumer 42, as described above. Based on the revised individualized discounted offer, one retailer is determined to provide the highest net value NV for consumer 42 and will assume or retain first position on optimized shopping list 148.

In another example, the optimal individualized discount needed to achieve a positive consumer purchasing decision for the product from consumer 42 involves a repetitive process beginning with the regular price less the maximum retailer acceptable discount and then incrementally decreasing the individualized discounted offer, i.e., raising the final price FP for the product, until the optimal individualized discount is determined. In this case, assume personal assistant engine 54 begins with the regular price less the maximum retailer acceptable discount for each retailer 46-50. The net value NV is determined for the DP1-DP3 product families, as described above, based on the final price FP equal to the regular price less the maximum retailer acceptable discount for the respective products. The highest net value retailer based on the regular price less the maximum retailer acceptable discount is tentatively in first position.

Retailers 46-50 do not necessarily want to offer every consumer 42-44 the maximum retailer acceptable discount as that would minimize profit for the retailer. Personal assistant engine 54 must determine the price tipping point for consumer 42 to make a positive purchasing decision, i.e., the lowest individualized discounted price that would entice the consumer to purchase one product. Any product with a net value less than one or negative net value given the maximum retailer acceptable discount is eliminated because there is no practical discount, i.e., a discount that still yields a profit for the retailer, that the retailer could offer which would entice consumer 42 to purchase the product. As for the other products, personal assistant engine 54 incrementally modifies the individualized discounted offer to a value less than the maximum retailer acceptable discount, i.e., raises the final price FP (regular price minus the individualized discount) to consumer 42. The modified individualized discounted offer can be a lesser incremental discount, e.g., the default discount or as little as one cent or fraction of one cent less than the maximum retailer acceptable discount. Personal assistant engine 54 recalculates the net value NV for consumer 42, as described above, for each of the remaining DP1-DP3 product families (except for eliminated products) at the modified final price point. Based on the modified individualized discounted offer, one retailer is determined to provide the highest net value NV greater than one or positive for consumer 42. The highest net value retailer based on the regular price less the modified individualized discounted offer moves into or retains first position.

In each of the above examples of determining net value for consumer 42, multiple brands and/or retailers for a single product can be placed on optimized shopping list 148. Personal assistant engine 54 can place, say the top two or top three net value brands and/or retailers on optimized shopping list 148, and allow the consumer to make the final selection and purchasing decision.

The consumer patronizes retailers 46-50, either in person or online, with optimized shopping list 148 and individualized discounted offers 150 from personal assistant engine 54 in hand and makes purchasing decisions based on the recommendations on the optimized shopping list. Based on optimized shopping list 148, consumer 42 patronizes the DP3 product family from retailer 50, BC2 product family from retailer 48, CS3 product family from retailer 50, BG1 product family from retailer 46, FP2 product family from retailer 48, and FV1 product family from retailer 46.

Personal assistant engine 54 helps consumers 42-44 quantify and evaluate, from a myriad of potential products on the market from competing retailers, a smaller, optimized list objectively and analytically selected to meet their needs while providing the best net value. The optimized shopping list 148 gives consumer 42 the ability to evaluate one or more recommended products or product families, each with an individualized discount customized for consumer 42 to make a positive purchasing decision. The consumers can rely on personal assistant engine 54 as having produced a comprehensive, reliable, and objective shopping list in view of the consumer's profile and weighted product preferences, as well as retailer product information, that will yield the optimal purchasing decision to the benefit of the consumer. The individualized discounted price should be set to trigger the purchasing decision. Personal assistant engine 54 helps consumers quantify and develop confidence in making a good decision to purchase a particular product or product family from a particular retailer at the individualized “one-to-one” discounted offer 150. While the consumer makes the decision to place the product in the basket for purchase, he or she comes to rely upon, or at least consider, the recommendations from consumer service provider 52, i.e., optimized shopping list 148 and individualized discounted offers 150 contributes to the tipping point for consumers to make the purchasing decision. The consumer model generated by personal assistant engine 54 thus in part controls many of the purchasing decisions and other aspects of commercial transactions within commerce system 40.

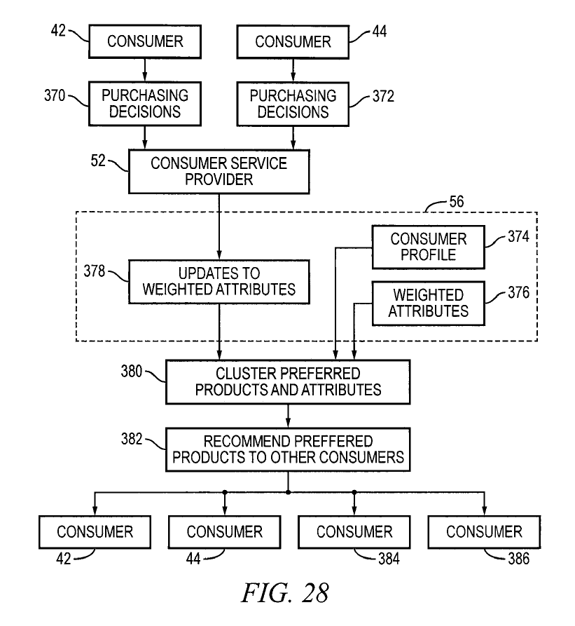

The purchasing decisions actually made by consumers 42-44 while patronizing retailers 46-50 are reported back to personal assistant engine 54 and retailers 46-50. FIG. 28 shows consumers 42 and 44 making purchasing decisions 370 and 372, respectively. Upon completing the check-out process, the consumer is provided with an electronic receipt of the purchases made, including purchasing decisions 370-372. The electronic receipt is stored in cell phone 66, downloaded to personal assistant engine 54, and stored in database 56 for comparison to optimized shopping list 148. The product information in database 56 can be updated from the electronic receipt. That is, the actual prices for the products on optimized shopping list 148 as charged by the retailer can be confirmed and updated as indicated. The actual purchasing decisions made when patronizing retailers 46-50 may or may not coincide with the preference levels or weighted attributes assigned by the consumer when constructing the original shopping list. For example, in choosing the canned soup, consumer 42 may have decided at the time of making the purchasing decision that one product attribute, e.g., product ingredients, was more important than another product attribute, e.g., brand. Consumer 42 made the decision to deviate from optimized shopping list 148, based on product ingredients, to choose a different product from the one recommended on the optimized shopping list. Personal assistant engine 54 can prompt consumer 42 for an explanation of the deviation from optimized shopping list 148, i.e., what product attribute became the overriding factor at the moment of making the purchasing decision. Personal assistant engine 54 learns from the actual purchasing decisions made by consumer 42 and can update the preference levels of the consumer weighted product attributes. The preference level for product ingredients can be increased and/or the preference level for brand can be decreased. The revised preference levels for the consumer weighted product attributes will improve the accuracy of subsequent optimized shopping lists. The pricing and other product information uploaded from cell phone 66 after consumer check-out to personal assistant engine 54 can also be used to modify the product information, e.g., pricing, in database 56.

Based on numerous shopping trips with retailers 46-50 using optimized shopping list 148, consumer 42 will migrate toward preferred products and identify specific attributes associated with the preferred products, as described in FIGS. 10-24. The preferred products and attributes of consumer 42 may change over time, but a present state of the preferred products and attributes can be readily determined from shopping list 318 or optimized shopping list 148 stored in database 56. Consumer service provider 52 maintains a profile for consumers 42-44 in database 56 based on personal information provided to consumer service provider 52, as described in FIG. 6, as well as weighted attributes as assigned by the consumer and updates to the weighted product attributes based on actual purchasing decisions from retailers 46-50. Consumer service provider 52 can cluster preferred products and attributes based on the consumer profile, weighted attributes as assigned by the consumer, and updates to the weighted product attributes based on actual purchasing decisions. FIG. 28 shows consumer profile 374, weighted attributes as assigned by the consumer 376, and updates to the weighted product attributes 378 based on purchasing decisions 370 and 372 being analyzed and evaluated by consumer service provider 52 to determine clustered preferred products and attributes in block 380. The analysis and evaluation of purchasing decisions 370 and 372 conducted by consumer service provider 54 includes comparison of consumer profiles, weighted attributes as assigned by the consumer, and updates to the weighted product attributes based on actual purchasing decisions by consumers 42-44. For example, products can be clustered based on similar gender, age, family size, age of children, occupation, medical conditions, shopping budget, or general product preferences of the consumer. The clustered preferred products and attributes 380 provide a basis to make recommendations to a consumer for products that have been identified as favorites of other similar consumers in block 382. The number of consumers in the clustering sample can range from one other consumer to hundreds of other consumers.

To demonstrate the process of making recommendations of clustered preferred products and attributes, assume consumers 42 and 44 have common preferences, characteristics, or demographics, e.g., consumers 42 and 44 each have families with small children. Consumer 42 regularly purchases a particular brand and size of cereal. Consumer 42 identifies the cereal with a high rating of preference, see FIG. 20. The purchasing pattern of consumer 42 with respect to the preferred cereal from block 370 reinforces the high attribute rating in block 378. Consumer 44 has not identified the cereal in his or her weighted product attributes nor made any purchase of the cereal. Consumer service provider 52 recognizes that consumers 42 and 44 have similar profiles and purchasing preferences, i.e., similar characteristics and demographics related to families with small children, and makes a recommendation to consumer 44 of the preferred cereal of consumer 42.

In another example, consumer 44 regularly purchases certain products with low sugar content or glycemic index (measure of effect of carbohydrates in food on blood sugar level). Consumer 44 is health conscious or possibly diabetic. Consumer 44 identifies one or more products with a high preference for low sugar content or glycemic index. The purchasing pattern of consumer 44 with respect to the preferred low sugar content or glycemic index products from block 372 reinforces the high attribute rating in block 378. Consumer 42 also preferred products with low sugar content or glycemic index based on his or her weighted product attributes, but has not identified the same products nor made any purchases of the same products as consumer 44. Consumer service provider 52 recognizes that consumers 42 and 44 have similar profiles and purchasing preferences, i.e., similar preferences for low sugar content or glycemic index, and makes a recommendation to consumer 42 of the preferred low sugar content or glycemic index products of consumer 44.

In another example, consumer 384 is a new subscriber to consumer service provider 52 and has a small number of products and weighted attributes defined in shopping list 318. Given the small shopping list 318, consumer service provider 52 recognizes that consumer 382 has a similar profile, i.e., common preferences, characteristics, or demographics, as consumers 42-44. The commonality between consumer 384 and consumer 42-44 can be based on gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumer service provider 52 makes one or more recommendations to consumer 384 of the preferred products of consumers 42-44 in block 382.

In another example, consumers 42-44 have both identified a particular product P1 on respective shopping lists 318 or optimized shopping lists 148. Product P1 is popular among many consumers. Consumer service provider 52 recognizes that consumer 386 has not identified product P1 as preferred nor made any purchases of the product. Based on the popularity of product P1 among consumers 42-44, consumer service provider 52 recommends product P1 to consumer 386.

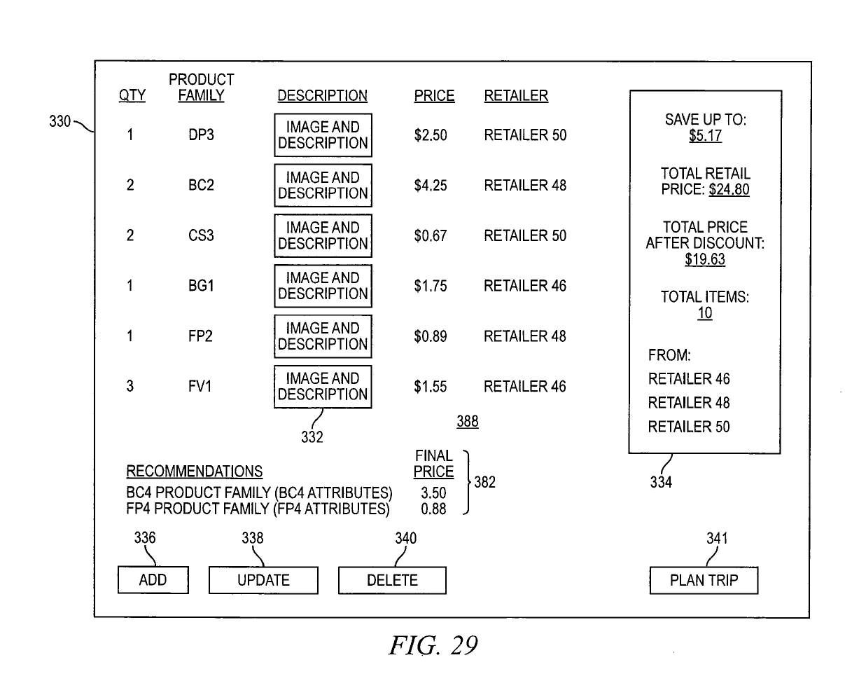

FIG. 29 shows shopping list 388, similar to FIG. 24, generated for consumer 384 or 386 with recommendations 382 from consumer service provider 52. Recommendations 382 originate from preferred products of consumers 42-44 and are clearly identified as suggestions or recommendations for consideration by consumer 384 or 386. Consumer 384 or 386 may or may not choose to purchase one or more products listed in recommendations 382. Retailers 46-50 authorize consumer service provider 52 to offer special introductory discounts to encourage consumer 384 or 386 to consider recommendations 382. The special introductory discount can be a price reduction for recommendation 382, accumulation of points to be redeemed for discounts for other products, or other incentive to encourage a decision by consumer 384 or 386 to try the product recommendation. Consumer 384 or 386 will likely appreciate the special discounts offered with recommendations 382 as an additional value for participation with consumer service provider 52. Retailers 46-50 build market share and increase sales, revenue, and profit by enabling consumer service provider 52 to make one or more product recommendations to a consumer based on preferred products of other consumers. The product recommendation of preferred products of other consumers allows the consumer to evaluate products that otherwise may not be considered and possibly make a sale for the retailer that otherwise would not have occurred.

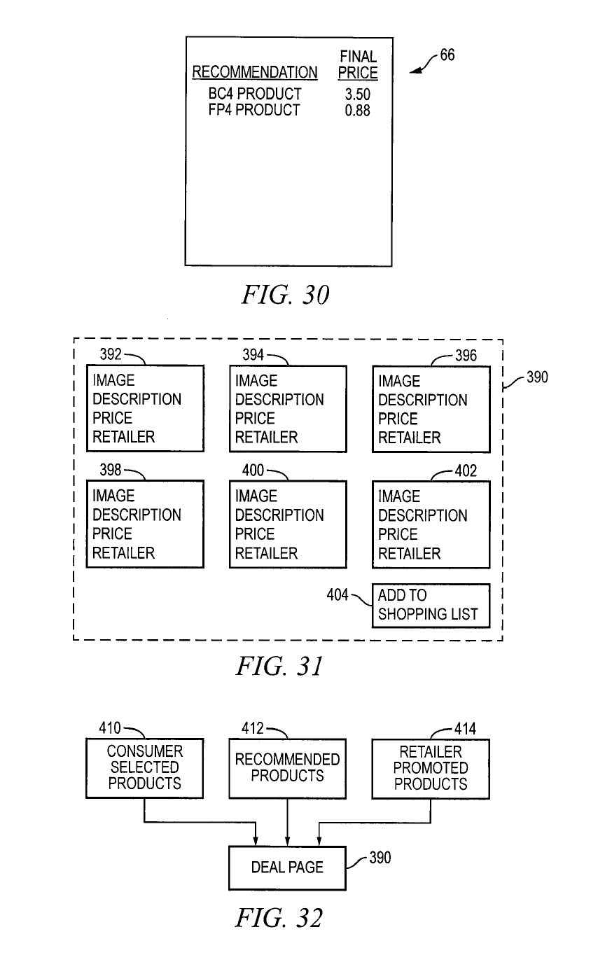

Recommendation 382 can also be transmitted to consumer 384 or 386 while on the premises of retailers 46-50. Consumer service provider 52 will know that consumer 384 or 386 is presently patronizing a particular retailer because the consumer may have communicated with the consumer service provider using cell phone 66. Alternatively, the GPS unit or other tracking device within cell phone 66 will provide the location of consumer 384 or 386. Consumer service provider 52 analyzes the preferred products and attributes of consumers 42-44 and determines recommendation 382 that may be of interest to consumer 384 or 386 based on similarity of preferences, characteristics, or demographics with respect to consumers 42-44. Consumer service provider 52 transmits recommendation 382 with special discount to consumer 384 or 386 through a wireless communication link, such as cell phone 66. Recommendation 382 appears on cell phone 66 for consideration by consumer 384 or 386, as shown in FIG. 30.

To further assist consumers 42-44, consumer service provider 52 provides an individualized marketing presentation tool or deal page 390 in FIG. 31. The consumer can access deal page 390 by selecting block 179 in FIG. 15. Deal page 390 is personalized to consumer 42 and includes a plurality of products or product families of interest from a plurality of retailers, that may or may not be already included in optimized shopping list 148, specifically selected by consumer service provider 52 from the product information stored in database 56 that would likely be of interest to the consumer. Deal page 390 includes product or product family of interest 392 from retailer 46 that consumer service provider 52 has determined would likely be of interest to consumer 42. Product 392 includes an image, description, and price of the product, as well as the identity and location of retailer 46 from database 56. The image of product 392 can be enlarged for further detail. The description of product 392 includes brand, size, ingredients, nutritional data, additives, and other product attributes. The price of product 392 includes regular price, sale price, discounted offer, and other incentive. Retailer 46 information includes name, type of retailer, location, and business hours. Consumer 42 can select preferred or potential retailers to be included in deal page 390 using the relator selector tool in FIG. 16. Consumer 42 can zoom in or zoom out to define the geographical shopping area, include or exclude specific retailers, and otherwise define the overall shopping parameters.

Deal page 390 further includes product or product family of interest 394 from retailer 48 that consumer service provider 52 has determined would likely be of interest to consumer 42. Product 394 is similar or related to product 392. In one embodiment, product 394 is a competing product as product 392, i.e., consumer 42 would likely consider product 394 as a substitute for product 392. Product 394 includes an image, description, and price of the product, as well as the identity and location of retailer 48. The image of product 394 can be enlarged for further detail. The description of product 394 includes brand, size, product availability, ingredients, nutritional data, allergy warnings, additives, and other product attributes. The price of product 394 includes regular price, sale price, discounted offer, and other incentive. Retailer 48 information includes name, type of retailer, location, and business hours. Product 394 is specifically selected by consumer service provider 52 for comparative shopping with respect to product 392.

Deal page 390 further includes product or product family of interest 396 from retailer 50 that consumer service provider 52 has determined would likely be of interest to consumer 42. Product 396 is similar or related to products 392 and 394. In one embodiment, product 396 is a competing product as products 392 and 394, i.e., consumer 42 would likely consider product 396 as a substitute for products 392 and 394. Product 396 includes an image, description, and price of the product, as well as the identity and location of retailer 50. The image of product 396 can be enlarged for further detail. The description of product 396 includes brand, size, ingredients, nutritional data, additives, and other product attributes. The price of product 396 includes regular price, sale price, discounted offer, and other incentive. Retailer 50 information includes name, type of retailer, location, and business hours. Product 396 is specifically selected by consumer service provider 52 for comparative shopping with respect to products 392 and 394.

Deal page 390 further includes product or product family of interest 398 from retailer 46, unrelated to products 392-396, that consumer service provider 52 has determined would likely be of interest to consumer 42. Product 398 includes an image, description, and price of the product, as well as the identity and location of retailer 46. The image of product 398 can be enlarged for further detail. The description of product 398 includes brand, size, ingredients, nutritional data, additives, and other product attributes. The price of product 398 includes regular price, sale price, individualized discounted offer, and other incentive. Retailer 46 information includes name, type of retailer, location, and business hours. Consumer 42 can select preferred or potential retailers to be included in deal page 390 using FIG. 16.

Deal page 390 further includes product or product family of interest 400 from retailer 48 that consumer service provider 52 has determined would likely be of interest to consumer 42. Product 400 is similar or related to product 398. In one embodiment, product 400 is a competing product as product 398, i.e., consumer 42 would likely consider product 400 as a substitute for product 398. Product 400 includes an image, description, and price of the product, as well as the identity and location of retailer 48. The image of product 400 can be enlarged for further detail. The description of product 400 includes brand, size, ingredients, nutritional data, additives, and other product attributes. The price of product 400 includes regular price, sale price, discounted offer, and other incentive. Retailer 48 information includes name, type of retailer, location, and business hours. Product 400 is specifically selected by consumer service provider 52 for comparative shopping with respect to product 398.

Deal page 390 further includes product or product family of interest 402 from retailer 50 that consumer service provider 52 has determined would likely be of interest to consumer 42. Product 402 is similar or related to products 398 and 400. In one embodiment, product 402 is a competing product of products 398 and 400, i.e., consumer 42 would likely consider product 402 as a substitute for products 398 and 400. Product 402 includes an image, description, and price of the product, as well as the identity and location of retailer 50. The image of product 402 can be enlarged for further detail. The description of product 396 includes brand, size, ingredients, nutritional data, additives, and other product attributes. The price of product 402 includes regular price, sale price, discounted offer, and other incentive. Retailer 50 information includes name, type of retailer, location, and business hours. Product 402 is specifically selected by consumer service provider 52 for comparative shopping with respect to products 398 and 400.

Consumer service provider 52 compiles product information from a variety of sources for presentation on deal page 390 as products of interest. FIG. 32 shows consumer service provider 52 accessing product information from consumer selected products or product families from database 56 in block 410 for presentation on deal page 390. Consumer 42 selects products or product families with weighted attributes in FIGS. 15-26. For example, consumer 42 selects milk in FIG. 19 with weighted product attributes, or brand A breakfast cereal with weighted product attributes in FIG. 20, or brand A coffee with weighted product attributes in FIG. 21. The selected product, e.g., milk, is presented on deal page 390 as product or product family 392 from retailer 46. Consumer service provider 52 also presents a milk product or product family 394 from retailer 48 similar or related to product 392, and a milk product or product family 396 from retailer 50 similar or related to products 392 and 394. Another selected product, e.g., brand A breakfast cereal, is presented on deal page 390 as product or product family 398 from retailer 46. Consumer service provider 52 also presents brand A breakfast cereal product or product family 400 from retailer 48 similar or related to product 398, and brand A breakfast cereal product or product family 402 from retailer 50 similar or related to products 398 and 400.

Consumer service provider 52 presents product or product family recommendations from FIGS. 28-29 in block 412 on deal page 390 as products of interest. Consumer service provider 52 determines products or product families, e.g., recommendation 382, that may be of interest to a consumer based on similarity of preferences, characteristics, or demographics with respect to other consumers. For example, many consumers select brand B breakfast cereal in FIG. 20 with weighted product attributes. Consumer service provider 52 presents the brand B breakfast cereal from FIG. 20 associated with another consumer that has similar preferences, characteristics, or demographics as a product recommendation for consumer 42. The product recommendation is shown as product 392. In addition, consumer service provider 52 also presents a brand B breakfast cereal as product or product family 394 from retailer 48 similar or related to product 392, and a brand B breakfast cereal as product or product family 396 from retailer 50 similar or related to products 392 and 394. In a similar manner, a brand A coffee from FIG. 20 associated with another consumer that has similar preferences, characteristics, or demographics consumer 42 is presented as a product recommendation for consumer 42. The product recommendation is shown as product 398 from retailer 46. Consumer service provider 52 also presents brand A coffee product or product family 400 from retailer 48 similar or related to product 398, and brand A coffee product or product family 402 from retailer 50 similar or related to products 398 and 400.

Consumer service provider 52 presents retailer promoted product or product family recommendations in block 414 on deal page 390 as products of interest. Consumer service provider 52 determines products or product families that retailers 46-50 would like to promote and may be of interest to consumer 42. For example, if consumer 42 has selected products associated with children or infants in FIGS. 15-26, then consumer service provider 52 presents related products or product families not previously considered by consumer 42. If retailers 46-50 want to promote a particular brand of infant formula and consumer 42 regularly purchases other infant products, then consumer service provider 52 introduces the brand of infant formula as product as product 392. In addition, consumer service provider 52 also presents infant formula as product or product family 394 from retailer 48 similar or related to product 392, and infant formula as product or product family 396 from retailer 50 similar or related to products 392 and 394. In a similar manner, if consumer 42 has selected products having low sugar content or glycemic index in FIGS. 15-26, then consumer service provider 52 presents related products or product families not previously considered by consumer 42. If retailers 46-50 want to promote a particular brand of low sugar canned fruit and consumer 42 regularly purchases similar products, then consumer service provider 52 introduces the brand of low sugar canned fruit as product 398 from retailer 46. Consumer service provider 52 also presents the low sugar canned fruit product or product family 400 from retailer 48 similar or related to product 398, and the low sugar canned fruit product or product family 402 from retailer 50 similar or related to products 398 and 400.

Products of interest 392-396 and 398-402 have associated image, description, price, and retailer in deal page 390. The price of product 392 can be the individualized personal offer for retailer 46; the price of product 394 can be the individualized personal offer for retailer 48; the price of product 396 can be the individualized personal offer for retailer 50, as described above. The individualized discounted offer is selected to likely trigger a positive purchasing decision by consumer 42 from the respective retailer.

Products of interest 392-396 and 398-402 increase the set of products under consideration by consumer 42. The consideration set arises from products having similar attributes as products previously identified by consumer 42 has being preferred or needed, from products preferred by other similarly situated consumers, from products that retailers 46-50 want to promote, or from alternative or substitute products of interest based on consumer feedback. The consideration set broadens the marketing base of consumer 42. Retailers 46-50 will want to encourage consumer 42 to increase his or her consideration set and can offer discounts for products of interest 392-396 and 398-402.

Consumer 42 reviews deal page 390 to compare and contrast products of interest 392-402 from different retailers 46-50 in making purchasing decisions. Consumer 42 can add the suggested products from deal page 390 to optimized shopping list 148 or shopping list 318 by selecting add button 404 in FIG. 31. Consumer 42 may be interested in one or more products of interest 392-396 and 398-402 but may want a better value. Consumer 42 can identify a price threshold for one or more products of interest 392-396 and 398-402 and forward that price threshold to consumer service provider 52. Retailers 46-50 are notified by consumer service provider 52 that consumer 42 will purchase the product for the price threshold. Retailers 46-50 can then choose to offer an individualized discounted offer 150 to consumer 42 that will achieve the price threshold. Alternatively, retailers 46-50 can offer substitute products of interest on deal page 390 that would achieve the price threshold set by consumer 42, e.g., store brand instead of name brand.

Deal page 390 can also trigger feedback from consumer 42 of products that would be of interest. If consumer 42 observes a product on deal page 390 that has desirable features but not quite what the consumer is looking for, then the consumer communicates a more complete description of the actual product of interest to consumer service provider 52. For example, consumer 42 may see a health care product with a given set of attributes (dietary supplement containing sugar) on deal page 390, but prefers a health care product with different attributes, e.g., dietary supplement without sugar. Retailers 46-50 are notified by consumer service provider 52 that consumer 42 will purchase the product with the given set of attributes. The feedback from consumer 42 in terms of price threshold and alternative products provides insight into the consumer purchasing mindset and help achieve the marketing goal of the consideration set of products.

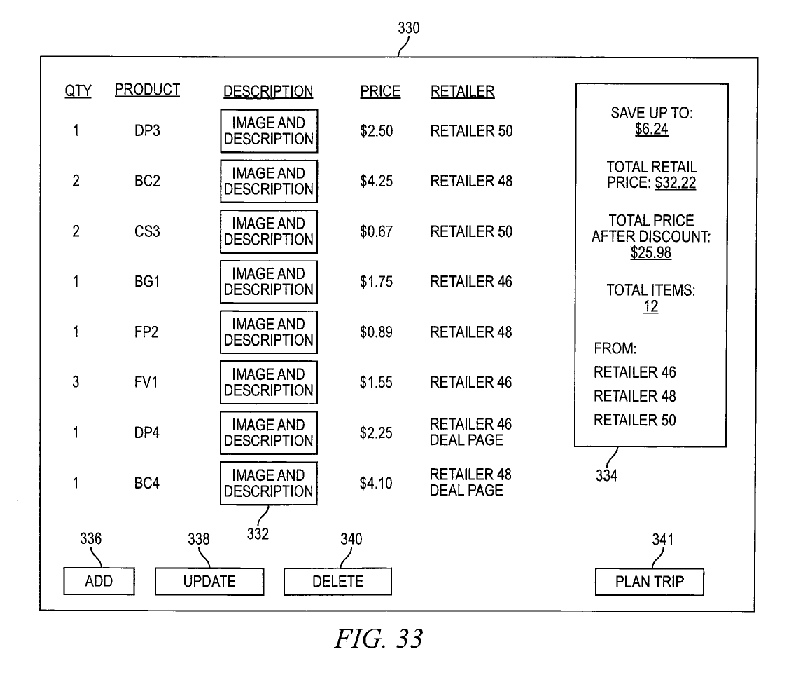

FIG. 33 shows additional products or product families of interest 392-402 from deal page 390 chosen by retailer 42 are added to optimized shopping list 148. Dairy product DP4 and breakfast cereal BC4 are selected by consumer 42 from products of interest 392-402 and added to optimized shopping list 148. Dairy product DP4 and breakfast cereal BC4 are identified as being selected from deal page 390 to remind and encourage consumer 42 to make use of the feature. The optimized shopping list 148 also displays in block 334 a “save up to” price of $6.24 as retail price less discounts, total retail price of $32.22, and total price after discounts of $25.98 for all 12 items. Deal page 390 is personalized to consumer 42 based on the consumer profile, prior product selections, product recommendations based on preferences of other consumers, retailer promoted products of interest, and alternative or substitute products of interest based on consumer feedback. The price of products 392-402 is selected to create a reasonable likelihood of a positive purchasing decision by consumer 42.

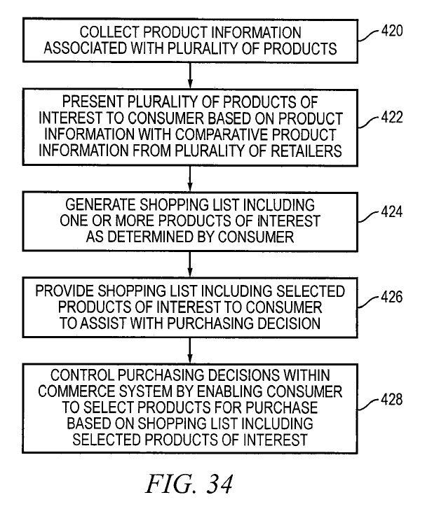

FIG. 34 illustrates a process for controlling a commerce system by enabling the consumer to select products for purchase based on the shopping list including the selected products of interest. In step 420, product information is collected associated with a plurality of products. The product information can be receiving the product information from a retailer in the form of transactional data or retrieved from a retailer website. In step 422, products of interest are presented to a first consumer based on the product information. The products of interest are selected based on a prior product selection by the first consumer, product selection by a second consumer, or retailer promoted product. The products of interest including comparative product information from a plurality of retailers. The comparative product information includes one or more of product image, brand, size, ingredients, nutritional data, additives, regular price, sale price, individualized or default discounted offer, name of retailer, type of retailer, location of retailer, and business hours of retailer. In step 424, a shopping list is generated including one or more selected products of interest as determined by the first consumer. In step 426, the shopping list including the selected products of interest is made available to the first consumer to assist with a purchasing decision. In step 428, the purchasing decision within the commerce system is controlled by enabling the first consumer to select products for purchase based on the shopping list including the selected products of interest.

In summary, the consumer service provider in part controls the movement of goods between members of the commerce system. Retailers offer products for sale. Consumers make decisions to purchase the products. Consumer service provider 52 offers consumers comparative shopping services, to aid the consumer in making purchasing decisions. In particular, consumer service provider 52 collects product information associated with a plurality of products. The product information can be receiving the product information from a retailer in the form of transactional data or retrieved from a retailer website. Consumer service provider 52 presents the products of interest to the consumer on a personalized deal page based on a prior product selection by the first consumer, product selection by a second consumer, or retailer promoted product. The products of interest including comparative product information from a plurality of retailers. The consumer selected one or more products of interest from the deal page. Consumer service provider 52 generates a shopping list including one or more of the products of interest. The shopping list is optimized based on the product information and weighted preferences for the product attributes for the product families. The optimized shopping list including the product families is made available to a consumer to assist with purchasing decisions. The optimized shopping list helps the consumer to make the purchasing decision based on comprehensive, reliable, and objective retailer product information for the product family, as well as an individualized discounted offer. The consumer makes purchases within the commerce system based on the optimized shopping list and product information compiled by the consumer service provider. By following the recommendations from the consumer service provider, the consumer can receive the most value for the money. The consumer service provider becomes the preferred source of retail information for the consumer, i.e., an aggregator of retailers capable of providing one-stop shopping.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
collecting product information associated with a plurality of products;
presenting a plurality of products of interest to a first consumer based on the product information, the products of interest including comparative product information from a plurality of retailers;
generating a shopping list including one or more selected products of interest as determined by the first consumer;
providing the shopping list including the selected products of interest to the first consumer to assist with a purchasing decision; and
controlling the purchasing decision within the commerce system by enabling the first consumer to select products for purchase based on the shopping list including the selected products of interest.

2. The method of claim 1, further including presenting one of the products of interest based on a prior product selection by the first consumer.

3. The method of claim 1, further including presenting one of the products of interest based on a product selection by a second consumer.

4. The method of claim 1, further including presenting one of the products of interest based on a retailer promoted product.

5. The method of claim 1, wherein the comparative product information is selected from the group consisting of product image, brand, size, ingredients, nutritional data, additives, regular price, sale price, discounted offer, name of retailer, type of retailer, location of retailer, and business hours of retailer.

6. The method of claim 1, wherein the comparative product information includes an individualized discounted offer for the first consumer.

7. A method of controlling a commerce system, comprising:
collecting product information associated with a plurality of products;
presenting a plurality of products of interest to a first consumer including comparative product information from a plurality of retailers; and
generating a shopping list including one or more selected products of interest as determined by the first consumer.

8. The method of claim 7, further including:
providing the shopping list including the selected products of interest to the first consumer to assist with a purchasing decision; and
controlling the purchasing decision within the commerce system by enabling the first consumer to select products for purchase based on the shopping list including the selected products of interest.

9. The method of claim 7, further including presenting one of the products of interest based on substitute product selection by the first consumer.

10. The method of claim 7, further including presenting one of the products of interest based on a product selection by a second consumer.

11. The method of claim 7, further including presenting one of the products of interest based on a retailer promoted product.

12. The method of claim 7, wherein the comparative product information is selected from the group consisting of product image, brand, size, ingredients, nutritional data, additives, regular price, sale price, discounted offer, name of retailer, type of retailer, location of retailer, and business hours of retailer.

13. The method of claim 7, wherein the comparative product information includes an individualized discounted offer for the first consumer.

14. A method of controlling a commerce system, comprising:
collecting product information associated with a plurality of products; and
presenting a plurality of products of interest to a first consumer including comparative product information from a plurality of retailers.

15. The method of claim 14, further including:
generating a shopping list including one or more selected products of interest as determined by the first consumer;
providing the shopping list including the selected products of interest to the first consumer to assist with a purchasing decision; and
controlling the purchasing decision within the commerce system by enabling the first consumer to select products for purchase based on the shopping list including the selected products of interest.

16. The method of claim 14, further including presenting one of the products of interest based on substitute product selection by the first consumer.

17. The method of claim 14, further including presenting one of the products of interest based on a product selection by a second consumer.

18. The method of claim 14, further including presenting one of the products of interest based on a retailer promoted product.

19. The method of claim 14, wherein the comparative product information is selected from the group consisting of product image, brand, size, ingredients, nutritional data, additives, regular price, sale price, discounted offer, name of retailer, type of retailer, location of retailer, and business hours of retailer.

20. The method of claim 14, wherein the comparative product information includes an individualized discounted offer for the first consumer.

21. A computer program product usable with a programmable computer processor having a computer readable program code embodied in a tangible computer usable medium for controlling a commerce system, comprising:
collecting product information associated with a plurality of products; and
presenting a plurality of products of interest to a first consumer including comparative product information from a plurality of retailers.

22. The computer program product of claim 21, further including:
generating a shopping list including one or more selected products of interest as determined by the first consumer;
providing the shopping list including the selected products of interest to the first consumer to assist with a purchasing decision; and
controlling the purchasing decision within the commerce system by enabling the first consumer to select products for purchase based on the shopping list including the selected products of interest.

23. The computer program product of claim 21, further including presenting one of the products of interest based on a prior product selection by the first consumer, a product selection by a second consumer, retailer promoted product, or substitute product selection by the first consumer.

24. The computer program product of claim 21, wherein the comparative product information is selected from the group consisting of product image, brand, size, ingredients, nutritional data, additives, regular price, sale price, discounted offer, name of retailer, type of retailer, location of retailer, and business hours of retailer.

25. The computer program product of claim 21, wherein the comparative product information includes an individualized discounted offer for the first consumer.
